(19) United States
(12) Patent Application Publication
(10) Pub. No.: US 2010/0107487 A1
(43) Pub. Date: May 6, 2010

(54) METHODS FOR ESTIMATING INTRINSIC AUTOTROPHIC BIOMASS YIELD AND PRODUCTIVITY IN UNICELLULAR PHOTOSYNTHETIC ALGAE

(76) Inventor: Alexandra D. Holland, Paris (FR)

Correspondence Address: SEED INTELLECTUAL PROPERTY LAW GROUP PLLC, 701 FIFTH AVE, SUITE 5400, SEATTLE, WA, 98104, US

(21) Appl. No.: 12/604,276

(22) Filed: Oct. 22, 2009

Related U.S. Application Data
(60) Provisional application No. 61/197,271, filed on Oct. 22, 2008.

(51) Int. Cl. A01G 7/00; G06F 17/10

(52) U.S. Cl. 47/1.4; 703/2

(57) ABSTRACT

A robust methodology is described herein for determining the algae biomass photoautotrophic yield (in gram of biomass synthesized per μmole of absorbed photons), which is useful for reliable biomass productivity estimates for selecting, comparing, and optimizing algae cultures for large-scale production. Another method is provided herein to increase dissolved inorganic carbon concentration and alleviate limitations common in aerated small-scale batches. This carbonate addition method allows for a more accurate determination of the algae culture photoautotrophic yield under small-scale experimental conditions. Also provided herein is a method for estimating a light spectrum-dependent scatter-corrected algae-specific absorption cross section, which permits the use of Beer's law to estimate the fraction of photons absorbed by a given algae culture. Determination of the algae photoautotrophic yield and absorption cross section enable a full photobioreactor parameterization and the resulting capacity to achieve highly controlled nutrients-supply conditions.

### CROSS-REFERENCE TO RELATED APPLICATION

This application claims the benefit under 35 U.S.C. §119(e) of U.S. Provisional Patent Application No. 61/197,271, filed Oct. 22, 2008, which is incorporated herein by reference in its entirety.

### BACKGROUND OF THE INVENTION

1. Field of the Invention

The present disclosure relates generally to biomass production from algae and, more particularly but not exclusively, to methods for determining biomass yield and biomass productivity from algae.

2. Description of the Related Art

Algal biomass production provides a means to convert light energy into storable chemical energy (i.e., biomass that can be further converted to methane or biodiesel), nutraceuticals, fertilizers, animal feed additives, and precursors for the chemical industry (Apt et al., J. Phycol. 35:215-26 (1999); Hu et al., The Plant Journal 54:621-39 (2008); Golueke et al., Appl. Envir. Microbiol. 7:219-27 (1959)). The algae culture autotrophic yield (in gram of biomass synthesized per μmole of absorbed photons) is the key parameter to assess maximum biomass productivity. However, in the context of algae strain selection, this parameter is not routinely determined and used for interspecies comparisons. A need exists in the art for providing a robust methodology to estimate algae cultures autotrophic yield and biomass productivity from simple experimental approaches.

### BRIEF SUMMARY OF THE INVENTION

In order to address inorganic carbon-limitation issues common in aerated batch algae cultures, which typically lead to an underestimation of the algae culture autotrophic yield Φ^{DCW} (in gram of biomass synthesized per μmole of absorbed photons), a Carbonate Addition Method (CAM) was developed in order to maintain high levels of dissolved inorganic carbon throughout the batch growth.

Provided herein is a method for determining the Exponential-to-Linear Transition autotrophic yield Φ^{DCW,ELT} of an algal culture that comprises a plurality of algal cells in a liquid algal growth medium, the method comprising: (a) measuring time t in hours (h) at a plurality of time points during growth of the algal culture, wherein the time t is adjusted to reflect the time the algal culture is exposed to light; (b) determining algal culture absorbance at each time t to provide a growth curve; (c) estimating from the growth curve, the corresponding algal biomass concentration C(t), using an experimentally determined correlation between absorbance and biomass concentration, wherein the biomass concentration is assumed to be constant throughout growth of the algal cells; (d) calculating the biomass production rate from the exponential growth behavior of C(t); (e) determining the maximum biomass production rate from (d); (f) determining the incident Photosynthesis Photon Flux Density I₀ (PPFD), in μE_{INCIDENT}·m⁻²·s⁻¹, wherein 1 Einstein (E) designates 1 mole of photons in the Photosynthetically Active Radiation (PAR) region in the 400-700 nm range; and

(g) calculating the Exponential-to-Linear Transition (ELT) autotrophic yield Φ^{DCW,ELT} of the algal culture according to the formula:

$${Φ}^{DCW , ELT} = \frac{{{V}_{C} \cdot \frac{d C}{d t} \vert}_{max}}{{I}_{0} \cdot {A}_{C}} \qquad Equation 9$$

wherein t is the time (in h) the algal culture is in the light phase; I₀ is the incident Photosynthesis Photon Flux Density (in μE_{INCIDENT}·m⁻²·h⁻¹); C(t) is the biomass concentration (in g_{DCW}·m⁻³) at time t; V_{c} is the batch culture constant volume (in m³); and A_{c} is the area of the culture perpendicular to the light source (in m²), thereby calculating the ELT autotrophic yield Φ^{DCW,ELT} (in g_{DCW}/μE_{absorbed}).

In another embodiment, a method is provided for determining the Williams-Duarte autotrophic yield Φ^{DCW,WD} of an algal culture that comprises a plurality of algal cells in a liquid algal growth medium, the method comprising: (a) measuring time t in hours (h) at a plurality of time points during growth of the algal culture, wherein the time t is adjusted to reflect the time the algal culture is exposed to light; (b) at each time t, determining the algal culture absorbance A(t) to provide a growth curve; (c) estimating from the growth curve, the corresponding algal biomass concentration C(t), using an experimentally determined correlation between absorbance and biomass concentration, k_{abs}, wherein k_{abs} is assumed to be constant throughout growth of the algal culture; (d) estimating from (c) the corresponding chlorophyll concentration C_{Ch1}(t), using an experimentally determined chlorophyll weight fraction, F_{Ch1}, wherein F_{Ch1} is assumed to be constant throughout growth, using the formula:

C_{Ch1}(t)=k_{abs}·F_{Ch1}·A(t) Equation 13

wherein t is the time the algal culture is in the light phase (in h); A is the algae culture absorbance (in Absorbance Units or AU) at time t; k_{abs} is the correlation between the absorbance and the biomass concentration (in g_{DCW}·m⁻³·AU⁻¹); F_{Ch1} is the chlorophyll weight fraction (in g_{Ch1}/g_{DCW}), thereby calculating the chlorophyll concentration C_{Ch1} (in g_{Ch1}·m⁻³);

(e) determining the incident Photosynthesis Photon Flux Density I₀ (PPFD), in μE_{INCIDENT}·m⁻²·s⁻¹, wherein 1 Einstein (E) designates 1 mole of photons in the Photosynthetically Active Radiation (PAR) region in the 400-700 nm range;

(f) calculating the chlorophyll autotrophic yield Φ^{Ch1}, in g Ch1 α/μE_{ABSORBED}, from a linear interpolation, according to the formula:

$$\frac{L ( {C}_{Chl} ( t ) - {C}_{Chl } ( {t}_{0} ) )}{{I}_{0}} \cdot \{ \begin{matrix}1 + \frac{1}{{α}_{Chl} L ( {C}_{Chl} ( t ) - {C}_{Chl} ( {t}_{0} ) )} \cdot \\ ln [ \frac{( 1 - exp ( - {α}_{Chl} {LC}_{Chl } ( t ) ) )}{( 1 - exp ( - {α}_{Chl} {LC}_{Chl} ( {t}_{0} ) ) )} ]\end{matrix} \} = {Φ}^{Chl} \cdot t \qquad Equation 14$$

wherein t is the time (in h) the algal culture is in the light phase; t₀ is the reference inoculation time (t₀=0 h); C_{Ch1} is the chlorophyll concentration (in g_{Ch1}·m⁻³); I₀ is the incident Photosynthesis Photon Flux Density (in μE_{INCIDENT}·m⁻²·h⁻¹); L is the depth of the culture (culture volume (m³)/area exposed to incident light (m²)); and α_{Ch1} is the chlorophyll specific autotrophic absorption, estimated to be 11.9 m²·g_{Ch}1⁻¹, thereby calculating the chlorophyll-specific autotrophic yield Φ^{Ch1}, in g_{Ch1}/μE_{ABSORBED}; and

(g) assuming a constant chlorophyll weight fraction F_{Ch1}, calculating the Williams-Duarte autotrophic yield Φ^{DCW,WD} of the algal culture according to the formula:

$${Φ}^{DCW , WD} = \frac{{Φ}^{Chl}}{{F}_{Chl}} \qquad Equation 15$$

wherein Φ^{Ch1} is the chlorophyll-specific autotrophic yield (in g_{Ch1}/μE_{ABSORBED}); F_{Ch1} is the chlorophyll weight fraction (in g_{Ch1}/g_{DCW}), thereby calculating the Williams-Duarte autotrophic yield Φ^{DCW,WD} (in g_{DCW}/μE_{ABSORBED}).

In another embodiment, a method is provided for determining the flux of photons absorbed I_{ABS}(C) by an algae culture of biomass concentration C, the method comprising: (a) at a given culture biomass concentration C_{E}, determining spectrophotometrically the algae culture absorbance spectrum A_{SCATTER}(λ) of a sample of algal cells over the PAR region; (b) performing discoloration of the algal cells to provide discolored algal cells, and at the given culture biomass concentration C_{E}, determining spectrophotometrically the algae culture absorbance spectrum A_{SCATTER}(λ) over the PAR region of the discolored algal cells; (c) at the given culture biomass concentration C_{E}, calculating the scatter-corrected absorbance spectrum A_{SC}(λ) over the PAR region, according to the formula:

A_{SC}(λ)=A_{RAW}(λ)−A_{SCATTER}(λ) Equation 16

wherein λ is a wavelength (in nm) in the PAR region (400-700 nm);

(d) spectrometrically acquiring the light source emission spectrum E_{LIGHT}(λ) (in count numbers as a function of λ, wherein count numbers are proportional to the number of photons emitted by the light source);

(e) normalizing the E_{LIGHT}(λ) spectrum over the PAR region, to evaluate the fraction of emitted photons at wavelength λ P_{LIGHT}(λ) according to the formula:

$${P}_{LIGHT} ( λ ) = \frac{{E}_{LIGHT} ( λ )}{{\sum }_{λ = 400}^{700} {E}_{LIGHT} ( λ )} ; \qquad Equation 17$$

(f) at the given culture biomass concentration C_{E}, determining the light spectrum-dependent algae-specific scatter-corrected absorption cross section, σ^{LS}, wherein σ^{LS} is assumed constant throughout growth of the algal culture, according to the formula:

$${σ}^{LS} = \frac{ln 10}{{C}_{E} \cdot {L}_{CUVETTE}} \cdot {\sum }_{λ = 400}^{700} {P}_{LIGHT} ( λ ) \cdot {A}_{SC} ( λ ) \qquad Equation 32$$

wherein λ is a wavelength (in nm) in the PAR region (400-700 nm); L_{CUVETTE} is the pathlength of the light through the spectrophotometer cuvette (in m); C_{E} is the algae biomass concentration (in g_{DCW}·m⁻³) at which the absorbance spectra are determined as set forth in (a)-(c); P_{LIGHT} is the wavelength-dependent photon fraction (dimensionless) of the light source, determined in steps (d)-(e); A_{SC}(λ) is the Scatter-Corrected (SC) culture absorbance spectrum, determined in step (c), thereby determining the algae-specific light source (LS)-dependent absorption cross section σ^{LS} (in m²·g_{DCW}⁻¹), wherein σ^{LS} is assumed to be constant throughout growth of the algal culture;

(g) measuring the incident Photosynthesis Photon Flux Density I₀ (PPFD), in μE_{INCIDENT}·m⁻²·s⁻¹, wherein 1 Einstein (E) designates 1 mole of photons in the Photosynthetically Active Radiation (PAR) region in the 400-700 nm range; and (h) determining the flux of photons absorbed I_{ABS} by a culture of biomass concentration C, according to the formula:

I_{ABS}(C)=I₀·[1−exp(−σ^{LS}·C·L)] Equation 19

wherein C is the algae culture biomass concentration (in g_{DCW}·m⁻³) which absorbs light; I₀ is the incident Photosynthesis Photon Flux Density (in μE_{INCIDENT}·m⁻²·h⁻¹); L is the depth of the culture (culture volume (m³)/area exposed to incident light (m²)); σ^{LS} is the algae-specific light source (LS)-dependent absorption cross section (in m²·g_{DCW}⁻¹) determined in step (f), thereby determining the flux of photons absorbed I_{ABS} (in μE_{ABSORBED}·m⁻²·h⁻¹).

In still another embodiment, a method is provided for determining the Williams-Ferrari-Holland autotrophic yield Φ^{DCW,WFH} of an algal culture that comprises a plurality of algal cells in a liquid algal growth medium, the method comprising: (a) measuring time t in hours (h) at a plurality of time points during growth of the algal culture, wherein the time t is adjusted to reflect the time the algal culture is exposed to light; (b) at time t, determining the algal culture absorbance A(t) of a sample of the algal cells to provide a growth curve; (c) estimating from the growth curve the corresponding algal biomass concentration C(t), using an experimentally determined correlation between absorbance and biomass concentration, k_{abs}, wherein k_{abs} is assumed to be constant throughout growth of the algal culture; (d) measuring the incident Photosynthesis Photon Flux Density I₀ (PPFD), in μ_{INCIDENT}·m⁻²·s⁻¹, wherein 1 Einstein (E) designates 1 mole of photons in the Photosynthetically Active Radiation (PAR) region in the 400-700 nm range; (e) at a given culture biomass concentration C_{E}, spectrophotometrically determining the algae culture absorbance spectrum A_{RAW}(λ) over the PAR region; (f) performing discoloration of the sample of the algal cells to provide discolored algal cells, and at the given culture biomass concentration C_{E}, spectrophotometrically determining the algae culture absorbance spectrum A_{SCATTER}(λ) over the PAR region of the discolored algal cells;

(g) at the given culture biomass concentration C_{E}, calculating the scatter-corrected absorbance spectrum A_{SC}(λ) over the PAR region, according to the formula:

A_{SC}(λ)=A_{RAW}(λ)−A_{SCATTER}(λ) (Equation 16

wherein λ is a wavelength (in nm) in the PAR region (400-700 nm);

(h) acquiring spectrometrically a light source emission spectrum E_{LIGHT}(λ) (in count numbers as a function of λ, wherein count numbers are proportional to the number of photons emitted by the light source);

(i) normalizing the E_{LIGHT}(λ) spectrum over the PAR region, to evaluate the fraction of emitted photons at wavelength λ P_{LIGHT}(λ) according to the formula:

$${P}_{LIGHT} ( λ ) = \frac{{E}_{LIGHT} ( λ )}{{\sum }_{λ = 400}^{700} {E}_{LIGHT} ( λ )} ; \qquad Equation 17$$

(j) at the given culture biomass concentration C_{E}, determining the light spectrum-dependent (LS) algae-specific scatter-corrected absorption cross section, σ^{LS}, wherein σ^{LS} is assumed to be constant throughout growth of the algal culture, according to the formula:

wherein

$${σ}^{LS} = \frac{ln 10}{{C}_{E} \cdot {L}_{CUVETTE}} \cdot {\sum }_{λ = 400}^{700} {P}_{LIGHT} ( λ ) \cdot {A}_{SC} ( λ ) \qquad Equation 32$$

λ is a wavelength (in nm) in the PAR region (400-700 nm); L_{CUVETTE} is the pathlength of the light through the spectrophotometer cuvette (in m); C_{E} is the algae biomass concentration (in g_{DCW}·m⁻³) at which the absorbance spectra are determined in steps (a)-(c); P_{LIGHT} is the wavelength-dependent photon fraction (dimensionless) of the light source, as determined in steps (d)-(e); A_{SC}(λ) is the Scatter-Corrected (SC) culture absorbance spectrum, determined in step (c), thereby determining the algae-specific light source (LS)-dependent absorption cross section σ^{LS} (in m²·g_{DCW}⁻¹), wherein σ^{LS} is assumed constant throughout growth of the algal culture; and

(k) determining the Williams-Ferrari-Holland autotrophic yield Φ^{DCW,WFH} of the algal culture, from a linear interpolation, according to the formula:

$$\frac{L}{{I}_{0}} \cdot \{ C - {C}_{0} + \frac{1}{{σ}^{LS} \cdot L} \cdot ln [ \frac{( 1 - exp ( - {σ}^{LS} \cdot L \cdot C ) )}{( 1 - exp ( - {σ}^{LS} \cdot L \cdot {C}_{0} ) )} ] \} = {Φ}^{DCW , WFH} \cdot t$$

wherein t is the time (in h) the algal culture is in the light phase; C is the algae culture biomass concentration (in g_{DCW}·m⁻³) at time t; C₀ is the algae culture biomass concentration (in g_{DCW}·m⁻³) at the inoculation time t₀=0; I₀ is the incident Photosynthesis Photon Flux Density (in μE_{INCIDENT}·m⁻²·h⁻¹); L is the depth of the culture (culture volume (m³)/area exposed to incident light (m²)); and σ^{LS} is the algae-specific light source (LS)-dependent absorption cross section (in m²·g_{DCW}⁻¹),

thereby calculating the Williams-Ferrari-Holland autotrophic yield Φ^{DCW,WFH} (in g_{DCW}/μE_{ABSORBED}). In certain embodiments, the method further comprises determining the rate of biomass fixation in a continuous bioreactor, wherein a light source (LS)-dependent algae-specific biomass production rate is determined according to the formula:

P_{DCW}^{LSi}=Φ^{DCW}·I_{abs}(C) Equation 2

wherein Φ^{DCW} is the algae culture autotrophic biomass yield (in g_{DCW}/μE_{ABSORBED}), determined as (i) Φ^{DCW,ELT} according to the method described above and herein, (ii) Φ^{DCW,WD} according to the method described above and herein, or (iii) Φ^{DCW,WFH} according to the method described above and herein, thereby determining P_{DCW}^{LSi}, the algae-specific Light Source i (LSi)-dependent algae-specific biomass production rate (in g_{DCW}·m⁻²·d⁻¹).

Also provided herein in another embodiment is a method for promoting growth of cultured algal cells comprising: (a) adding carbonate to an algal culture that comprises a plurality of algal cells in a liquid growth medium having a pH that is conducive to growth of the algal cells, and thereby obtaining a concentration of inorganic carbon (Ci) dissolved in the algal culture; (b) subsequent to (a), adjusting the pH to neutralize the medium to obtain a pH conducive to growth of the algal cells; and (c) subsequent to (b), sealing the algal culture (which prevents CO₂ escape into the air). In another particular embodiment, the above method further comprises repeating the steps of adding carbonate and adjusting pH two, three, four, five, six, seven, eight, nine, ten or more times, thereby to maintain the increased concentration of inorganic carbon dissolved in the algal culture. In yet another embodiment, the step of adjusting the pH of the algal culture comprises maintaining dissolved carbon dioxide in the liquid algal growth medium at a dissolved carbon dioxide level that is greater than a gaseous atmospheric carbon dioxide level.

In another embodiment, the method described above and herein for promoting growth of cultured algal cells further comprises the method for determining the Exponential-to-Linear Transition (ELT) autotrophic yield, Φ^{DCW,ELT}, as described above and herein. In yet another embodiment, the method further comprises the method for determining the Williams-Duarte (WD) autotrophic yield, Φ^{DCW,WD}, as described and herein, and in still another embodiment, the method further comprises determining a light spectrum-dependent algae-specific scatter-corrected absorption cross section σ, which enables the use of Beer's law to estimate the fraction of light absorbed by the culture. In another embodiment, the method for promoting growth of cultured algal cells further comprises the method for determining the Williams-Ferrari-Holland (WDH) autotrophic yield, Φ^{DCW,WFH}, as described above and herein. In other specific embodiments, the method for promoting growth of cultured algal cells further comprises the calculation of productivity estimates, as well as the algae bioreactor parametrization, both of which use the σ and Φ^{DCW} parameters defined above and herein.

In certain embodiments of the methods described above and herein for the step of determining autotrophic yields and/or determining biomass production rates, the methods further comprise performing the calculation(s) according to the respective formulas using a computer comprising a computer readable program for performing the calculation(s).

As used herein and in the appended claims, the singular forms “a,” “and,” and “the” include plural referents unless the context clearly dictates otherwise. Thus, for example, reference to “an algal cell” or “the algal cell” includes reference to one or more cells (i.e., a plurality of cells) and equivalents thereof known to those skilled in the art, and so forth. The term “comprising” (and related terms such as “comprise” or “comprises” or “having” or “including”) is not intended to exclude that in other certain embodiments, for example, an embodiment of any composition of matter, composition, method, or process, or the like, described herein may “consist of” or “consist essentially of” the described features. In addition, the term “or” is generally employed to include “and/or” unless the content clearly dictates otherwise.

Reference throughout this specification to “one embodiment,” or “an embodiment,” or “in another embodiment,” or “in some embodiments” means that a particular referent feature, structure, or characteristic described in connection with the embodiment is included in at least one embodiment. Thus, the appearance of the phrases “in one embodiment,” or “in an embodiment,” or “in another embodiment” in various places throughout this specification are not necessarily all referring to the same embodiment. Furthermore, the particular features, structures, or characteristics may be combined in any suitable manner in one or more embodiments.

### BRIEF DESCRIPTION OF THE DRAWINGS

FIG. 1 (top panel A) shows examples of growth curves for aerated batch cultures. Corresponding local productivity indicator (LPI) given in A₆₈₀/h is shown in lower panel (B). For exponential growth behaviors, the exponential fits are shown, and the corresponding fitted productivity indicators (FPI) are shown in the legend of top panel (A). The maximum LPI is given in the legend for each culture as shown in lower panel (B).

FIG. 2 presents examples of average biomass productivities calculated from Φ^{DCW, ELT} (aerated batch cultures, Local Productivity Estimates), assuming an average incident light of 1000 μE/m²/s and a 12 h-day (i.e., the time the algal culture is exposed to light per 24 h-period. Error bars (Standard Deviations) are given for the total biomass estimated productivity.

FIG. 3 illustrates the low concentration of dissolved inorganic carbon in aerated aqueous solutions at neutral pH. Dissolved inorganic carbon (CO₂ and carbonate species) concentrations were calculated at various pH using Henry's law and the carbonate species pKa. In the 7-8.5 pH-range, the maximum Ci concentration is on the order of 2 mM.

FIG. 4 presents examples of growth curves for carbonate-amended/sealed batch cultures. Fitted Productivity Indicators (FPI) are estimated from the exponential growth behaviors (solid line or dotted line for each curve). The maximum FPI is used for the Φ^{DCW, ELT} determination, and used for productivity estimates as shown in FIG. 5.

FIG. 5 presents examples of average biomass productivities calculated from Φ^{DCW, ELT} (carbonate-amended/sealed batch cultures, maximum Fitted Productivity Estimates), assuming an average incident light of 1000 μE/m²/s and a 12 h-day. Error bars (Standard Deviations) are given for the total biomass estimated productivity. The range of estimated productivities derived from aerated batch growth behaviors is shown by the hatched region (see FIG. 2).

FIG. 6 graphically represents the left-hand side to the Equation 23 as a function of time for four algae cultures grown in nutrients-replete, carbonate-amended conditions. The slope corresponds to Φ^{Ch1} (g Ch1 α/μE_{ABSORBED}).

FIG. 7 graphically represents the left-hand side to the Equation 41 as a function of time for four algae cultures grown in nutrients-replete, carbonate-amended conditions. The slope corresponds to Φ^{DCW, WFH} (g_{DCW}/μE_{ABSORBED}).

FIG. 8 illustrates the consistency of the three presented methods for calculation of the autotrophic yields. Area maximum productivity estimates were calculated from Φ^{DCW, ELT}, Φ^{DCW, WD} and Φ^{DCW, WFH}, respectively, assuming nutrients-replete conditions, an average incident light of 1000 μE/m²/s and a 12 h-day. Error bars (Standard Deviations) are given for the total biomass estimated productivity.

### DETAILED DESCRIPTION

This work broadly applies to any photoautotrophic unicellular biological material grown in liquid cultures, which can utilize light as its sole energy source (‘photo’) to form complex biomass molecules from inorganic carbon, such as CO₂ or carbonate (‘autotroph’). For simplicity and clarity, the term “autotrophic” may be used in lieu of “photoautotrophic,” and the term “algae culture” has the same meaning as “photoautotrophic unicellular biological material in a liquid culture.” The present disclosure relates generally to biomass production from algae and, more particularly but not exclusively, to methods for determining photoautotrophic yields and estimating culture biomass productivity. As is familiar to a person skilled in the art, batch growth broadly designates a biomass culturing condition in which no liquid volume is added or removed; fed-batch designates a biomass culturing condition in which a nutrient feed is added continuously to the biomass culture, but no culture volume is removed.

Methods are described herein to permit selection of algal strains best suited for large scale culture and for determining culture conditions that maximize biomass productivity. The methods described herein may be performed in pilot-scale (i.e., small batch cultures, such as 100 ml culture volume) and applied to scaled-up bioproduction, based on photoprinciples that involve comparable light exposures through agitation configurations. Prior to this time, algal strains for large scale culture have been chosen primarily according to their growth rate properties: faster growing strains have been selected for scale up (e.g., Sheehan et al., A Look Back at the U.S. Department of Energy's Aquatic Species. Program—Biodiesel from Algae. July 1998). However, optimization of biomass productivity is better accomplished by choosing an algal strain with a high autotrophic yield, which is expressed herein in gram of biomass synthesized per μmole of absorbed photons. As described herein, strain selection based on maximum growth rate, which is most commonly practiced in the field (e.g., Sheehan et al., supra), is not an optimum approach to estimate a strain's capacity to efficiently convert light energy into biomass energy, and may even provide inaccurate results. Assuming nutrients-replete conditions and vigorous agitation for adequate light distribution, the methodology described herein permits reliable comparison between algal species based on their maximum autotrophic yield. Further, batch quantitative growth response studies can be used for optimization of medium composition, symbiotic relationships and temperature conditions. The autotrophic yield and productivity estimates determined from algal growth characteristics in small batch using the methods described herein can be used to predict accurately whether the algal culture can be successfully adapted to efficient large-scale biomass production. Accordingly, these methods described herein contribute to enhancing algal culture technology for use of algae biomass as an energy source.

By way of background, autotrophic yields have been traditionally estimated using two methods described in the literature, both of which require the unwieldy measurements of CO₂ uptake or O₂ evolution. First, quantum efficiency, reported in mole carbon (mole C) fixed (or mole O₂ evolved) per mole photons absorbed, requires additional quantification of the levels of absorbed photons using the integrating sphere method (see, e.g., Lal et al., Plant Cell Physiol. 36:1311-17 (1995); Bannister et al., J. Plankton Res. 6:275-94 (1984); Welschmeyer et al., J. Phycol. 17; 283-93 (1981)). Second, Photosynthesis-Irradiance (PI) curves (see, e.g., Grobbelaar, “Photosynthetic response and acclimation of microalgae to light fluctuations,” p. 671-683. In D. V. S. Rao (ed.), Algal Cultures Analogues of Blooms and Applications, vol. 2 Science Publishers (2006); Grobbelaar et al., J. Appl. Phycol. 8:335-43 (1996)) can be used to determine the maximum photosynthetic efficiency. Given the culture area exposed to light and the mass of chlorophyll α (Ch1 α) in the tested culture, the ratio of the reported rate of photosynthesis (in μmol of O₂ evolved·mg Ch1 α⁻¹·h⁻¹) to the corresponding incident irradiance (in μE·m⁻²·s⁻¹) can be normalized to yield an efficiency parameter (in mole C fixed/mole photons) as a function of irradiance, with a maximum efficiency in the tested range of irradiances. PI curves, however, are often mistaken for an intrinsic parameter of algal cultures, and inherently depend on culture concentration (Grobbelaar et al. (1996) supra), physiological state, and growth cell geometry. The effective use of PI curves has proved often limited by the incomplete report of such parameters. While similar, the maximum autotrophic yield Φ^{DCW} (in g_{DCW}/μE_{ABSORBED}) described herein is more simply based on the algae culture batch-growth behavior.

Methods are described herein for determining the algae culture autotrophic yield on a Dry Cell Weight (DCW) basis Φ^{DCW}, in g_{DCW}/μE_{ABSORBED}, where 1 Einstein (E) designates 1 mole of photons. Hence, Φ^{DCW} (in gram of biomass synthesized per μmole of absorbed photons) is a yield which assesses the capacity of an algae culture to convert light energy into biomass energy.

In-turn, by determining Φ^{DCW}, a corresponding biomass maximum area productivity (in g_{DCW}·m⁻²·d⁻¹) can be estimated, given a measured average daily incident Photosynthesis Photon Flux Density (PPFD, in μE·m⁻²·s⁻¹) I₀ in the Photosynthesis Active Radiation (PAR) region (400-700 nm range) and bioreactor geometry. Assuming that all the incident light I₀ is absorbed by the algae culture, the maximum area productivity P_{DCW}^{MAX} can be calculated according to the formula:

P_{DCW}^{MAX}=Φ^{DCW}·I₀ Equation 1

wherein

I₀ is the flux of incident photons (in μE_{INCIDENT}·m²·d⁻¹);

Φ^{DCW} is the autotrophic biomass yield (in g_{DCW}/μE_{ABSORBED});

thereby calculating P_{DCW}^{MAX}, the maximum area productivity (in g_{DCW}·m⁻²·d⁻¹).

More generally, a fraction I_{ABS} of the incident PPFD is used for photosynthesis, which depends on the algae biomass concentration C and the light source i (LSi) used, and the corresponding area productivity P_{DCW}^{LSi} can be calculated according to the formula:

P_{DCW}^{LSi}=Φ^{DCW}·I_{ABS}(C) Equation 2

wherein

C is the algae culture biomass concentration (in g_{DCW}·m⁻³);

I_{ABS} is the flux of absorbed photons (in μE_{ABSORBED}·m⁻²·d⁻¹);

Φ^{DCW} is the autotrophic biomass yield (in g_{DCW}/μE_{ABSORBED});

thereby calculating P_{DCW}, the area productivity (in g_{DCW}·m⁻²·d⁻¹).

While the incident PPFD I₀ can be easily measured using a quantum meter and the known geometry of a bioreactor, estimation of I_{ABS}, the flux of absorbed photons, has not been readily and routinely achieved prior to the use of the methods described herein. A simple method for estimating I_{ABS} is described herein.

Determination of the Autotrophic Yield from Batch Growth Behavior

Assuming a CO₂-replete environment, the absence of high density steric effects and an intermediate light regime, which supports carbon fixation without photoinhibition, batch growth of autotrophic algae corresponds to fed-batch growth of heterotrophs. With respect to heterotrophs, reducing equivalents are provided by the continuously fed organic carbon substrate, while for autotrophs, constant illumination provides the continuous supply of light converted to reducing equivalents by the PSI. This analogy informs the use of the algal batch growth curve to calculate the culture volumetric productivity as the time derivative of the biomass concentration (see, e.g., Kim et al., Biotechnology and Bioengineering 43:892-98 (1994)). Accordingly, given the reactor geometry and substrate feeding rate, the fed-batch heterotrophic yield is reported in g_{BIOMASS}/g_{SUBSTRATE} and the autotrophic yield in g_{DCW}/μmole_{PHOTONS} (or g_{DCW}/μE).

Hence, autotrophic growth of unicellular algae in batch reactors (such as a flask) is analogous to heterotrophic bacterial growth in fed-batch reactors. In the former, the source of energy is the light, whereas in the latter, the source of energy is a carbon source (such as glucose). This analogy will guide the establishment of the growth behavior descriptive equations and the existence of an intrinsic autotrophic yield Φ, expressed in grams of fixed biomass (or gram of Dry Cell Weight) per mole absorbed photons.

Nutrients-replete algae culture growth under light excess follows an exponential behavior in batch cultures, independent of the light input and is described by:

$$\frac{d ( {V}_{c} \cdot C )}{d t} = {μ}_{max} \cdot {V}_{c} \cdot C \qquad Equation 3$$

wherein

t is the time (in h) that the algal culture is in the light phase,

C is the algae culture biomass concentration (in g_{DCW}·m⁻³) at time t;

V_{c} is the batch culture constant volume (in m³);

μₘₐₓ is the maximum growth rate (in h⁻¹).

Time t as used herein represents an adjusted time (i.e., duration, length of time) to reflect time along the growth curve (e.g., number of hours) of light exposure, which is the total culture time reduced by the time (e.g., hours) when the cultures are in dark phase (i.e., time t is total culture time truncated for the duration in the dark phase). By way of example, the time points at which samples may be removed from the algal culture and analyzed according to the methods described herein may be every two, three, four, or five hours, every six to ten hours, every eleven to twenty hours, or every twenty-one to thirty or forty hours, or every fifty or sixty hours, or at greater or small intervals. The time t that the algal culture is in light phase is then determined for use in the methods described above and herein. A person skilled in the art readily understands that a first time point may be represented as t₁, which is the time point at which a measurement of a sample of the algal culture is performed, for example, obtaining the absorbance (a first absorbance A₁) of a sample of the algal culture. Accordingly, samples are obtained and analyzed at t₁₋ₙ, wherein n is at least 3 and may be any number between 3 and 100.

In accordance with engineering principles, perfect mixing is assumed and nutrients-replete conditions are satisfied. Shaking (i.e., agitating) the cultures effectively distributes the light energy homogeneously within the culture, analogous to a sugar feed for heterotrophs.

The light input becomes limiting when the light is completely absorbed by the culture. The culture biomass production rate transitions from an exponential to a linear behavior, and the following equation describes the system behavior:

$$\frac{d {( photons \vert}_{batch} )}{d t} = {I}_{0} \cdot {A}_{C} - ( {I}_{OUT} \cdot {A}_{OUT} ) - \frac{1}{{Φ}^{DCW}} \frac{d ( {V}_{c} \cdot C )}{d t} - {m}_{P} \cdot {V}_{c} \cdot C \qquad Equation 4$$

wherein

t, Vc, C are defined above;

photons|_{batch} is the number of free photons retained in the culture (in μE);

I₀ is the incident PPFD (in μE·m⁻²·h⁻¹);

A_{c} is the area of the culture perpendicular to the light source (in m²);

I_{OUT}·A_{OUT} is the transmitted PPFD (in μE·h⁻¹);

Φ^{DCW} is the autotrophic yield (in g_{DCW}/μE_{ABSORBED});

m_{P} is the maintenance energy to sustain biomass (in μE·g_{DCW}⁻¹·h⁻¹).

In essence, the light is either absorbed by the biomass or scattered/transmitted through the batch vessel. Hence the photons are not allowed to “accumulate” in the batch reactor, such that:

$$\frac{d {( photons \vert}_{batch} )}{d t} = 0 \qquad Equation 5$$

wherein the variables are defined as described above.

Assuming the light becomes limiting, the fraction of the incident light which is not absorbed by the algae becomes negligible:

I₀·A_{C} [symbol] I_{OUT}·A_{OUT} Equation 6

wherein the variables are defined above.

The algae biomass maintenance is believed to be negligible, thus setting m_{P}=0. Indeed, during the 8 h-dark phase, no biomass loss is observed (See Example 1 and Example 2).

Under these assumptions, the growth behavior model simplifies to a linear growth behavior described by:

$$\frac{d ( {V}_{c} \cdot C )}{d t} = {Φ}^{DCW} \cdot {I}_{0} \cdot {A}_{C} \qquad Equation 7$$

wherein the variables are defined above.

Because unabsorbed photons cannot accumulate within the batch culture volume, which has a constant volume V_{C}, the Exponential-to-Linear Transition (ELT) is well defined and the following equalities hold:

$${{\frac{d ( {V}_{c} \cdot C )}{d t} \vert}_{transition} = {Φ}^{DCW} \cdot {I}_{0} \cdot {A}_{C} = {μ}_{max} \cdot {V}_{C} \cdot C \vert}_{transition} \qquad Equation 8$$

The Exponential-to-Linear Transition (ELT) occurs at the point of maximum biomass productivity, which allows for the determination of Φ^{DCW, ELT} according to the formula:

$${Φ}^{DCW , ELT} = \frac{{{V}_{C} \cdot \frac{d C}{d t} \vert}_{max}}{{I}_{0} \cdot {A}_{C}} \qquad Equation 9$$

where

$${\frac{d C}{d t} \vert}_{max}$$

can be calculated from the algae culture batch growth behavior, either from the late exponential phase, or from the linear phase.

Absorbance measurements using a spectrophotometer at a chosen wavelength (e.g., 680 nm) is a common method to estimate algae biomass concentration (see, e.g., Xu et al., Journal of Biotechnology, 126, 499 (2006); Chang, E H. and Yang, S S, Bot. Bull. Acad. Sin., 44, 43 (2003)). Wavelengths in the 540-750 nm range are commonly used by a person skilled in the art, and are chosen such that a linear correlation between biomass concentration and absorbance can be achieved. Indeed, scattering, as measured by absorbance in this range, permits an estimate of biomass concentration. Accordingly for any algal species, linear correlations between the culture absorbance (e.g., A₆₈₀) and the culture biomass concentration C (in g_{DCW}·m⁻³) can be readily established.

In the exponential phase of growth, in several regions of the growth curve, the growth rate μ (in h⁻¹) is evaluated from an exponential fit between two or more points (using software such as Microsoft Excel). In each region where μ is fitted, the maximum biomass production rate is calculated as Cₗₐₛₜ ·μ (from Equation 3 with constant volume V_{c}), where the biomass concentration Cₗₐₛₜ is taken as the highest biomass concentration in the region under consideration, at the latest time point. For a given growth curve, among all the regions in which μ is calculated, the highest maximum biomass production rate is used for the determination of the autotrophic yield Φ^{DCW,ELT} Examples 1 and 2 illustrate this method in greater detail.

Hence, the method for determining the Exponential-to-Linear Transition autotrophic yield Φ^{DCW,ELT}, of an algal culture that comprises a plurality of algal cells in a liquid algal growth medium, is provided herein, the method comprising: (a) measuring the time t in hours (h) at a plurality of time points during growth of the algal culture, wherein the time t is adjusted to reflect the time (e.g., number of hours) that the culture is exposed to light (i.e., time of light exposure); thus, the total culture time is reduced by the time (e.g., hours) when the cultures are in dark phase; (b) at each time t, determining the algal culture absorbance (i.e., at each time t, determining A(t) of a sample of the algal culture; for example, obtaining A(t)₁ at t₁, A(t)₂ at t₂, and A(t)₃ at t₃ for each time point t₁₋ₙ, wherein n is any integer)) to provide a growth curve; (c) estimating from the growth curve determined in (b) the corresponding algal biomass concentration C(t), using an experimentally determined correlation between absorbance and biomass concentration, which is assumed to be constant throughout growth of the algal cells in the culture; (d) calculating the biomass production rate from the exponential growth behavior of C(t); (e) determining the maximum biomass production rate from (d); (f) using, for example a quantum meter, measuring the incident Photosynthesis Photon Flux Density (PPFD) I₀ in μE_{INCIDENT}·m⁻²·s⁻¹, wherein 1 Einstein (E) designates 1 mole of photons in the Photosynthetically Active Radiation (PAR) region in the 400-700 nm range; (g) calculating the Exponential-to-Linear Transition (ELT) autotrophic yield Φ^{DCW,ELT} of the algal culture according to the formula:

$${Φ}^{DCW , ELT} = \frac{{{V}_{C} \cdot \frac{d C}{d t} \vert}_{ma x}}{{I}_{0} \cdot {A}_{C }} \qquad Equation 9$$

wherein

t is the time the algal culture is in the light phase (in h);

I₀ is the incident Photosynthesis Photon Flux Density (in μE_{INCIDENT}·m⁻²·h⁻¹);

C(t) is the biomass concentration (in g_{DCW}·m⁻³) at time t;

V_{c} is the batch culture constant volume (in m³); and,

A_{c} is the area of the culture perpendicular to the light source (in m²);

thereby calculating the ELT autotrophic yield Φ^{DCW,ELT} (in g_{DCW}/μE_{absorbed}).

Example 1 illustrates determination of the autotrophic yield Φ^{DCW,ELT} in aerated batch culture.

As a corollary to the analogy between heterotrophic fed-batch and autotrophic batch growth, the maximum growth rate μₘₐₓ is an indicator of the growth yield (whether Y_{X/S} or Φ^{DCW}). The parameter μₘₐₓ is only relevant if:
determined during exponential growth;
reported along with the maximum culture density at which this rate is observed;
reported along with the levels of incident light, the vessel geometry, the culture volume and culture area exposed to light.

Thus, for algae selection, Φ^{DCW}(g_{DCW}/μE_{ABSORBED}) is the relevant parameter to determine, not μₘₐₓ alone. However, publications in the art that describe algae strains for biomass/lipid production do not report the complete set of parameters (listed above) for adequately determining autotrophic yield Φ^{DCW}.

### Establishment of a Protocol to Maintain Elevated Dissolved Inorganic Carbon Concentrations in Batch Cultures

Typically, in methods currently performed in the art, the source of carbon for culturing algae is carbon dioxide (CO₂), which is generally introduced into algal cultures by bubbling an enriched CO₂ stream into the culture. In order to bypass cumbersome and poorly controlled CO₂-bubbling, an improved method is described herein for adding dissolved inorganic carbon and maintaining an increased level of dissolved inorganic carbon (including in the form of carbon dioxide) in small batch autotrophic cultures (e.g., 100 ml culture volume in a 250 ml flask) by introducing carbonate as the source of inorganic carbon (Ci). Alleviating Ci-limitation is instrumental to avoid underestimation of the culture autotrophic yield.

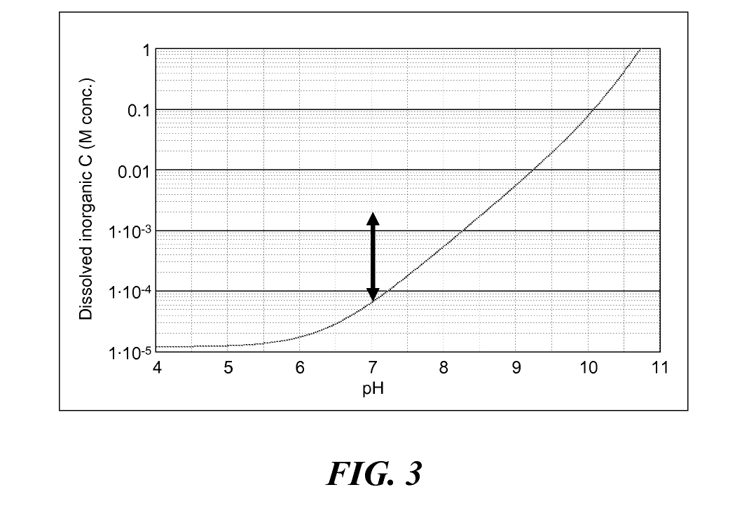

In order to address Ci-limitation issues observed in aerated batch cultures (see Example 1), the following Carbonate Addition Method (CAM) was developed. This method consists of (a) adding carbonate to an autotrophic culture that comprises a plurality of cells in a liquid growth medium having a pH that is conducive to growth of the algal cells, and thereby obtaining a concentration of inorganic carbon (Ci) dissolved in the algal culture; and (b) subsequent to (a), adjusting the pH of the algal culture, for example, by adding dilute acid solution, if the algal culture has a basic pH, to neutralize the medium after carbonate addition in order to reach a pH conducive to growth (e.g., pH 6.8-7.6); and (c) subsequent to (b), sealing the algal culture to prevent CO₂ escape into the air. To limit release of gaseous carbon dioxide into the atmosphere, which results from equilibration, the steps are performed in a timely manner—for example, within 5-10 min after agitation of the flasks has been stopped (See Example 1, FIG. 3).

In one embodiment, the method further comprises maintaining the pH at a level that is conducive to growth of the algal cells. In a particular embodiment, the above method further comprises repeating the steps of adding carbonate and adjusting the pH two, three, four, five, six, seven, eight, nine, ten or more times (e.g., 11-20, 21-40, or more), thereby to maintain the increased concentration of inorganic carbon dissolved in the algal culture. In a certain embodiment, the step of adjusting the pH comprises neutralizing the algal culture. In yet another embodiment, the step of adjusting the pH of the algal culture comprises maintaining dissolved carbon dioxide in the liquid algal growth medium at a dissolved carbon dioxide level that is greater than a gaseous atmospheric carbon dioxide level.

A source of carbonate, which is a salt or ester of carbonic acid, (for example, a carbonate salt (e.g., sodium, ammonium, or potassium carbonate) or a carbonate mineral (e.g., calcium carbonate) is introduced into an algal culture to provide an increased concentration of Ci. In an aqueous solution, carbonate (i.e., carbonate ion, CO₃²⁻), bicarbonate (HCO₃), carbonic acid (H₂CO₃), and carbon dioxide (CO₂) exist in a dynamic equilibrium. In acidic conditions, aqueous carbon dioxide is the main form. Accordingly, after addition of carbonate, the pH is neutralized which leads to a transient increase in dissolved carbon dioxide (i.e., increase the level of Ci). Sealing the flask enriches the headspace of gaseous CO₂, and prevents release into the atmosphere. This in turn increases the dissolved CO₂ concentration (according to Henry's law) to levels more conducive to growth. Following the CAM protocol, carbonate is added periodically at various time points throughout the growth of the algal culture.

Cultures may be grown for 1-10 days or 11-20 days or longer. At each time point, the pH of the algal culture medium is determined, carbonate is added to the desired concentration, and the pH of the growth media is adjusted, typically decreased by addition of an acid (e.g., hydrochloric acid), which neutralizes the carbonate addition and neutralizes growth-induced medium alkalinization.

The increased level of dissolved Ci is maintained in the algal culture by, at least in part, minimizing the exchange of carbon dioxide in the culture with gases in the normal atmosphere. To maintain the increased level of Ci in the culture (i.e., maintain the level of carbon dioxide) for a given period of time, a vessel in which the algal culture is growing is made air tight or sealed in some manner to reduce or prevent carbon stripping (i.e., displacement of dissolved carbon by another gas). For example, a vessel containing an algal culture may be hermetically sealed, or gas impermeable materials may be used that are placed over any opening in the vessel that is exposed to normal atmospheric conditions. Exemplary materials used for sealing the vessel include PARAFILM or aluminum foil covered with PARAFILM, or other materials with which a person skilled in the art will be familiar. As another alternative, an algal culture vessel may be placed in a chamber or larger vessel that provides an environment that is enriched for carbon dioxide (i.e., has an increased percent of CO₂ compared with normal atmosphere).

The time between each addition of carbonate is adjusted (i.e., the amount of time between each addition of carbonate is not necessarily the same) such that biomass production (determined using a 50% C on a dry weight basis) is not limited by the concentration of inorganic carbon (Ci). Typically, carbonate is added to a concentration between 8-10 mM in the algal culture. An algal culture that will consume 10 mM carbonate (final concentration obtained in the algal culture at a first time point) during two time points will also, most likely, elevate the culture pH to a lethal or stressful level (e.g., pH>pH 9). This was observed when algal cultures were grown in MOPS and Tris buffered media (10 mM buffer). Such buffers are reportedly inhibitory to algal growth such that 10 mM was chosen as a maximum. Accordingly, carbonate is added at a concentration that avoids excessive growth-induced alkalinization (pH greater than 9.5). Duration between time points (time truncated for dark phases) needs to be adjusted such that approximately 70% of the added carbonate is used, which depends on the expected biomass production. This duration τ between two time points, t₁ and t₂, during which the algae culture consumes approximately 70% of the carbonate added at t₁, can be estimated using the following equations:

$$\begin{matrix}C ( {t}_{2} ) = C ( {t}_{1} ) \cdot exp ( μ \cdot τ ) & Equation 10 \\ [ C ( {t}_{2} ) - C ( {t}_{1} ) ] \cdot \frac{Fc}{1000 \cdot FWc} = 0.70 \cdot {C}_{add}^{CO 2} ( {t}_{1} ) & Equation 11 \\ C ( t ) = {k}_{a bs} \cdot A ( t ) & Equation 12\end{matrix}$$

wherein

t is the time in hours that the algal culture is in light phase (i.e., duration in the light phase since inoculation of the algal culture (in h));

t₁ is a time point prior to time t₂ by a duration τ (in h);

C(t) is the algae culture biomass concentration (in g_{DCW}·m⁻³) at time t;

A(t) is the algae culture absorbance (in Absorbance Units or AU) at a chosen wavelength (e.g., A₆₈₀) at time t;

k_{abs} is the correlation between the absorbance (e.g., A₆₈₀) and the biomass concentration (in g_{DCW}·m⁻³·AU⁻¹);

μ is the algae culture growth rate (in h⁻¹), evaluated at time t₁;

Fc is the carbon mass fraction in the algal biomass (dimensionless, ˜0.50);

FWc is the formula weight of elemental carbon (˜12 g/mol);

C_{add}^{CO2} final molar concentration of carbonate added at time t₁ (˜0.01 M).

From equations 10-12, the duration τ between t₁ and t₂ can be estimated as follows:

$$τ = \frac{1}{μ} ln [ \frac{0.70 \cdot {C}_{add} ( {t}_{1} )}{Fc} \frac{1000 \cdot FWc}{{k}_{ab s} \cdot {A}_{680} ( {t}_{1} )} + 1 ] \qquad ( 20 )$$

wherein the variables are defined above.

A pH that is “about” a recited pH value such as a desired pH value (e.g., neutrality, or “about” pH 7, or a slightly acidic pH, such as a pH that is “about” pH 6.9, 6.8, 6.7, 6.6, 6.5, 6.4, 6.3, 6.2 or 6.1). Hence, “about” in the context of pH may be understood to represent a quantitative variation in pH that may be more or less than the recited value by no more than 0.5 pH units, more preferably no more than 0.4 pH units, more preferably no more than 0.3 pH units, still more preferably no more than 0.2 pH units, and most preferably no more than 0.1-0.15 pH units. As also noted herein, a substantially constant pH (e.g., a pH that is maintained within the recited range for an extended time period) may be from about pH 6.5 to about pH 8.5, from about pH 6.0 to about pH 8.0, from about pH 6.3 to about pH 7.5, from about pH 6.5 to about pH 7.4, or from about pH 6.6 to about pH 7.2, or any other pH or pH range as described herein. Similarly, in the context of other quantitative parameters “about” may be understood to reflect a quantitative variation that may be more or less than the recited value by 0.5 logarithmic units (e.g., “logs” or orders of magnitude), more preferably no more than 0.4 log units, more preferably no more than 0.3 log units, still more preferably no more than 0.2 log units, and most preferably no more than 0.1-0.15 log units.

Thus, unexpected advantages were obtained by sealing the aqueous algal culture system (after carbonate addition and neutralization), which according to non-limiting theory, desirably and via equilibrium forces, resulted in liquid algal culture medium formulations having sustainable elevated aqueous liquid-dissolved inorganic carbon concentrations (e.g., increased in a statistically significant or biologically significant manner over those detectable in unsealed systems) relative to Ci concentrations of the prior art culture media. Improved biomass yield is attained by repeated addition of carbonate to “re-charge” the aqueous algal culture medium to maintain elevated Ci concentrations.

The concurrent development of theoretical derivations (determination of the Φ^{DCW} from the batch growth behavior) and experimental methods (CAM) provides a means to select, compare cultures, and optimize conditions based on batch autotrophic yield estimates Φ^{DCW} in lieu of μₘₐₓ, which was shown to be an irrelevant criterion. Further, this combined approach affords a much better understanding of the achievable productivities in outdoor ponds and other large-scale systems.

Example 2 shows that heightened autotrophic yields Φ^{DCW,ELT} (i.e., a statistically or biologically significant increase in yield compared with a non-CAM algal culture) are determined from CAM cultures, thus supporting the Ci-limitation in aerated cultures.

Productivity Estimate from Algal Batch Growth Behavior by Using the Williams Equation and the Duarte Extinction Coefficient

In one embodiment, a second method for calculating the autotrophic yield is provided. This method uses a time-dependent estimate of Chlorophyll a concentration in the algal culture over time t, wherein t is time of culture, which is generally expressed in hours. The biomass percent Chlorophyll a on a DCW basis is assumed constant over the course of the growth as the cells are unstressed. The time t is adjusted to reflect the time (e.g., number of hours) of light exposure; thus, the total culture time is reduced by the time (e.g., hours) when the cultures are in dark phase. Cultures are grown in nutrients-replete conditions, using the CAM as described above. The autotrophic yield Φ^{DCW} (g_{DCW}/μE_{ABSORBED}) determined using the calculations and measurements described below is referred to as the Williams-Duarte (WD) autotrophic yield (Φ^{DCW,WD}) (g_{DCW}/μE_{ABSORBED}).

Ragonese and Williams published an integrated model of the algae batch-growth behavior, which fits both the exponential and light-limited part of the curve (Ragonese et al., Biotechnology and Bioengineering 10:83-88 (1968)). The Ragonese and Williams analysis, which uses the Beer-Lambert law to estimate the fraction of light absorbed by the culture, therefore relies on the ability to estimate the culture extinction coefficient. However, Ragonese and Williams do not clearly state the method used to estimate the culture extinction coefficient, and their model was never used thereafter. In 1998, Duarte et al. derived the in vivo autotrophic contribution to light absorption in the Mediterranean Bay of Blanes, and reported a light absorption coefficient of 11.9 m²·g Ch1 α⁻¹ for autotrophic organisms (Limnol. Oceanog. 43:236-44 (1998)). The determination of this in vivo parameter enables the use of the Beer-Lambert law to estimate the fraction of light absorbed by growing autotrophic cultures, upon determination of the culture Ch1 α concentration. In turn, this enables the general use of the 1968 Ragonese and Williams descriptive batch growth equations. The Duarte et al. (supra) contribution has never been used in a modeling context.

The Ragonese and Williams equation presented below was modified to display the use of S.I. units and incorporate the culture extinction coefficient derived from Duarte et al. (supra). Also presented herein is a method for determining the Williams-Duarte autotrophic yield Φ^{DCW,WD}, of an algal culture that comprises a plurality of algal cells in a liquid algal growth medium, the method comprising: (a) measuring the time t in hours (h) at a plurality of time points during growth of the algal culture, wherein the time t is adjusted to reflect the time (e.g., number of hours) of light exposure; thus, the total culture time is reduced by the time (e.g., hours) when the cultures are in dark phase; (b) at time t, determining the algal culture absorbance A(t) (i.e., at each time t, determining A(t) of a sample of the algal culture; for example, obtaining A(t)₁ at t₁, A(t)₂ at t₂, and A(t)₃ at t₃ etc., for each time point t₁₋ₙ, wherein n is any integer) to provide a growth curve; (c) estimating from the growth curve determined in (b) the corresponding algal biomass concentration C(t), using an experimentally determined correlation between absorbance and biomass concentration, k_{abs}, assumed constant throughout growth of the algal cells; (d) estimating from (c) the corresponding chlorophyll concentration C_{Ch1}(t), using an experimentally determined chlorophyll weight fraction, F_{Ch1}, assumed constant throughout growth, using the formula:

C_{Ch1}(t)=k_{abs}·F_{Ch1}·A(t) Equation 13

wherein

t is the time (in h) the algal culture is in the light phase (i.e., duration of the light phase in hours);

A is the algae culture absorbance (in Absorbance Units or AU), at a chosen wavelength appropriate for the algal strain, at time t;

k_{abs} is the correlation between the absorbance and the biomass concentration (in g_{DCW}·m⁻³·AU⁻¹);

F_{Ch1} is the chlorophyll weight fraction (in g_{Ch1}/g_{DCW});

thereby calculating the chlorophyll concentration C_{Ch1} (in g_{Ch1}·m⁻³);

(e) determining incident Photosynthesis Photon Flux Density (PPFD) I₀ (for example, by using a quantum meter to measure PPFD), in μE_{INCIDENT}·m⁻²·s⁻¹, wherein 1 Einstein (E) designates 1 mole of photons in the Photosynthetically Active Radiation (PAR) region in the 400-700 nm range; (f) calculating the chlorophyll autotrophic yield Φ^{Ch1}, in g Ch1 α/μE_{ABSORBED}, from a linear interpolation, according to the formula:

$$\frac{L ( {C}_{Chl} ( t ) - {C}_{Chl} ( {t}_{0} ) )}{{I}_{0}} \cdot \{ \begin{matrix}1 + \frac{1}{{α}_{Chl} L ( \begin{matrix}{C}_{Chl} ( t ) - \\ {C}_{Chl} ( {t}_{0} )\end{matrix} )} \cdot \\ ln [ \frac{( 1 - exp ( - {α}_{Chl} {LC}_{Chl} ( t ) ) )}{( 1 - exp ( - {α}_{Chl} {LC}_{Chl} ( {t}_{0} ) ) )} ]\end{matrix} \} = {Φ}^{Chl} \cdot t \qquad Equation 14$$

wherein

t is the time (in hours) the algal culture is in light phase (i.e., the duration in the light phase);

t₀ is the reference inoculation time (t₀=0 h);

C_{Ch1} is the chlorophyll concentration (in g_{Ch1}·m⁻³);

I₀ is the incident Photosynthesis Photon Flux Density (in μE_{INCIDENT}·m⁻²·h⁻¹);

L is the depth of the culture (culture volume (m³)/area exposed to incident light (m²));

α_{Ch1} is the chlorophyll specific autotrophic absorption, estimated by Duarte et al. (Limnol. Oceanog. 43:236-44 (1998)) to be 11.9 m²·g_{Ch}1⁻¹;

thereby calculating the chlorophyll-specific autotrophic yield Φ^{Ch1}, in g_{Ch1}/μE_{ABSORBED};

(g) assuming a constant chlorophyll weight fraction F_{Ch1}, and calculating the Williams-Duarte autotrophic yield Φ^{DCW,WD} of the algal culture according to the formula:

$${Φ}^{DCW , WD} = \frac{{Φ}^{Chl}}{{F}_{Chl}} \qquad Equation 15$$

wherein

Φ^{Ch1} is the chlorophyll-specific autotrophic yield (in g_{Ch1}/μE_{ABSORBED});

F_{Ch1} is the chlorophyll weight fraction (in g_{Ch1}/g_{DCW});

thereby calculating the Williams-Duarte autotrophic yield Φ^{DCW,WD} (in g_{DCW}/μE_{ABSORBED}).

### Estimation of the Flux of Photons Absorbed by an Algal Culture Using an Experimentally Determined Algae-Specific Light Source-Dependent Absorption Cross Section

To bypass the cumbersome use of an integrating sphere to measure the scatter-corrected absorption spectrum of an algae culture (Merzlyak and Naqvi 2000; Journal of Photochemistry and Photobiology B: Biology 58(2-3): 123-129), pigment discoloration may be performed by methods practiced in the art, for example, by using sodium hypochlorite (NaClO) according to the method described by Ferrari et al. (J. Phycol. 35:1090-98 (1999)). Indeed, after pigments discoloration, the algae culture absorbance solely reflects scatter. The A_{RAW}(λ) absorbance spectrum in the Photosynthetically Active Radiation (PAR) range (400 nm-700 nm) is determined in a sample of algal cells before pigment discoloration, and the A_{SCATTER}(λ) is determined in an algal cell sample after complete culture discoloration of the algal cells (5-10 min after bleaching by NaClO addition). Ferrari et al. (supra) reported that high concentrations of Cl⁻ ions formed a colloid suspension upon NaClO addition. Hence, for non fresh-water species ([Cl⁻]>30 mM), the chloride salts were substituted to sulfate salts in the discoloration assay medium (described above). The effects of NaClO addition on the medium absorbance spectrum were negligible. The scatter-corrected (SC) culture absorbance spectrum is determined by subtracting the spectrum of the bleached culture from the spectrum of the unbleached culture.

Also provided herein is a method for determining the flux of photons absorbed I_{ABs}(C) by an algae culture of biomass concentration C, the method comprising: (a) at a given culture biomass concentration C_{E}, determined from an absorbance measurement as detailed above, a spectrophotometer is used to measure (i.e., spectrophotometrically determine) the algae culture absorbance spectrum A_{RAW}(λ) of a sample of algal cells over the PAR region; (b) at the given culture biomass concentration C_{E}, a spectrophotometer may be used to measure (i.e., spectrophotometrically determine) the algae culture absorbance spectrum A_{SCATTER}(λ) over the PAR region after discoloration of the algal cells (i.e., the sample of algal cells is discolored, according to methods described herein and practiced in the art, prior to measuring the algae culture absorbance spectrum A_{SCATTER}(λ) over the PAR region); (c) at the given culture biomass concentration C_{E}, calculating the scatter-corrected absorbance spectrum A_{SC}(λ) over the PAR region, according to the formula:

A_{SC}(λ)=A_{RAW}(λ)−A_{SCATTER}(λ) Equation 16

wherein λ is a wavelength (in nm) in the PAR region (400-700 nm);

(d) using a spectrometer (e.g., an Ocean Optics™ fiber optic spectrometer), to acquire the light source emission spectrum E_{LIGHT}(λ) (in count numbers as a function of λ, wherein count numbers are proportional to the number of photons emitted by the light source); (e) normalizing the E_{LIGHT}(λ) spectrum over the PAR region, to evaluate the fraction of emitted photons at wavelength λ P_{LIGHT}(λ) according to the formula:

$${P}_{LIGHT} ( λ ) = \frac{{E}_{LIGHT} ( λ )}{{\sum }_{λ = 400}^{700} {E}_{LIGHT} ( λ )} \qquad Equation 17$$

(f) at the given culture biomass concentration C_{E}, determining the light spectrum-dependent algae-specific light source (LS)-dependent absorption cross section, σ^{LS}, assumed constant throughout growth, according to the formula:

$${σ}^{LS} = \frac{ln 10}{{L}_{CUVETTE} \cdot {C}_{E }} \cdot {\sum }_{λ = 400}^{700} {P}_{LIGHT} ( λ ) \cdot {A}_{SC} ( λ ) \qquad Equation 18$$

wherein

λ is a wavelength (in nm) in the PAR region (400-700 nm);

L_{CUVETTE} is the pathlength of the light through the spectrophotometer cuvette (in m);

C_{E} is the algae biomass concentration (in g_{DCW}·m⁻³) at which the absorbance spectra are determined as described in steps (a)-(c);

P_{LIGHT} is the wavelength-dependent photon fraction (dimensionless) of the light source, as determined in steps (d)-(e);

A_{SC}(λ) is the Scatter-Corrected (SC) culture absorbance spectrum, as determined in step (c),

thereby determining the algae-specific light source (LS)-dependent absorption cross section σ^{LS} (in m²·g_{DCW}⁻¹), which is assumed to be constant throughout growth;

(g) measuring the incident Photosynthesis Photon Flux Density (PPFD) I₀ (for example, by using a quantum meter), in μE_{INCIDENT}·m⁻²·s⁻¹, wherein 1 Einstein (E) designates 1 mole of photons in the Photosynthetically Active Radiation (PAR) region in the 400-700 nm range; and (h) determining the flux of photons absorbed I_{ABS} by a culture of biomass concentration C, according to the formula:

I_{ABS}(C)=I₀·[1−exp(−σ^{LS}·C·L)] Equation 19

wherein

C is the algae culture biomass concentration (in g_{DCW}·m⁻³) that absorbs light;

I₀ is the incident Photosynthesis Photon Flux Density (in μE_{INCIDENT}·m⁻²·h⁻¹);

L is the depth of the culture (culture volume (m³)/area exposed to incident light (m²));

σ^{LS} is the algae-specific light source (LS)-dependent absorption cross section (in m²·g_{DCW}⁻¹), as determined in step (f),

thereby determining the flux of photons absorbed I_{ABS} (in μE_{ABSORBED}·m⁻²·h⁻¹).

The proof for Equation 18 is provided below. Beer's law is re-derived below to account for the polychromatic nature of the light source. In the case of algae, the wavelength λ spans the Photosynthetically Active Radiation (PAR) region, between 400 and 700 nm.

At each wavelength λ, the light absorbed between the depth z and z+dz is proportional to the incident light flux at depth z, the concentration of algae cells C, the absorption cross-section σ, and the liquid depth Δz through which the light travels. The following photon-flux balance describes this phenomenon as follows:

I(z+dz,λ)−I(z,λ)=−C·(λ)·I(z,λ)·Δz Equation 20

wherein

z is the distance (in m) from the culture edge at which the light is incident;

λ is the light wavelength (in nm);

I(z, λ) is the photon flux density (in μE·m⁻²·s⁻¹) at distance z from the sample edge, at wavelength λ;

C is the algae culture biomass concentration (in g_{DCW}·m⁻³);

σ(λ) is the algae culture absorption cross section (in m²·g_{DCW}⁻¹) at a given λ;

Δz depth (in m) over which the photon-flux balance is performed.

Performing the summation of Equation 20 over the PAR spectrum wavelengths leads to:

$${\sum }_{λ = 400}^{700} I ( z + dz , λ ) - I ( z , λ ) = - C \cdot Δ z \cdot {\sum }_{λ = 400}^{700} I ( z , λ ) \cdot σ ( λ ) \qquad Equation 21$$

where the variables are described in Equation 20.

The photon flux at depth z at each wavelength can be decomposed as follows:

I(z,λ)=P_{LIGHT}(λ)·I(z) Equation 22

wherein

z is the distance (in m) from the culture edge at which the light is incident;

λ is the light wavelength (in nm);

I(z, λ) is the photon flux density (in μE·m⁻²·s⁻¹) at distance z from the sample edge, at wavelength λ;

P_{LIGHT} is the wavelength-dependent photon fraction (dimensionless) of the light source, determined from Equation 17.

Combining Equations 21 and 22, and taking the limit Δz→0 of the resulting expression leads to:

$${\sum }_{λ = 400}^{700} {P}_{LIGHT} ( λ ) \cdot \frac{\partial I ( z )}{\partial z} dz = - C \cdot dz \cdot {\sum }_{λ = 400}^{700} {P}_{LIGHT} ( λ ) \cdot I ( z ) \cdot σ ( λ ) \qquad Equation 23$$

wherein the variables are defined in Equations 20 and 22.

From the definition of P_{LIGHT} (Equation 17), the following relation holds:

$${{\sum }_{λ}}^{spectrum} {P}_{LIGHT} ( λ ) = 1 \qquad Equation 24$$

The summation and separation of variables in Equation 23, along with the Equation 24, yield:

$$\frac{dI ( z )}{I ( z )} = - C \cdot dz \cdot {\sum }_{λ = 400}^{700} {P}_{LIGHT} ( λ ) \cdot σ ( λ ) \qquad Equation 25$$

wherein the variables are defined in Equations 20 and 22.

Integration of the Equation 25 between depths z=0 and z=L yields:

$$- ln ( \frac{{I}_{L}}{{I}_{0}} ) = C \cdot L \cdot {\sum }_{λ = 400}^{700} {P}_{LIGHT} ( λ ) \cdot σ ( λ ) \qquad Equation 26$$

wherein

I₀ is the incident photon flux density (in μE·m⁻²·s⁻¹) at distance z=0 from the sample edge where the light is incident;

I_{L} is the incident photon flux density (in μE·m⁻²·s⁻¹) at distance z=L from the sample edge where the light is incident;

C is the algae culture biomass concentration (in g_{DCW}·m⁻³);

L is the culture depth (in m) over which the photon flux balance is performed;

P_{LIGHT} is the wavelength-dependent photon fraction (dimensionless) of the light source, determined from Equation 17;

σ(λ) is the algae culture absorption cross section (in m²·g_{DCW}⁻¹) at a given λ.

The overall scatter-corrected (SC) absorbance over the PAR spectrum, A_{SC}^{PAR}, which accounts for light absorbed over all wavelengths of the PAR spectrum, is defined as:

$${A}_{SC}^{PAR} = - log ( \frac{{I}_{L}}{{I}_{0}} ) = - ln ( \frac{{I}_{L}}{{I}_{0}} ) \cdot \frac{1}{ln 10} \qquad Equation 27$$

where the variables are defined in Equation 26.

Combining Equations 26 and 27 yields:

$${A}_{SC}^{PAR} = \frac{C \cdot L}{ln 10} \cdot {\sum }_{λ = 400}^{700} {P}_{LIGHT} ( λ ) \cdot σ ( λ ) \qquad Equation 28$$

wherein the variables are defined in Equations 26 and 27.

At a single wavelength λ, Beer's law states that:

$$σ ( λ ) = \frac{ln 10 \cdot {A}_{SC} ( λ )}{C \cdot L} \qquad Equation 29$$

wherein

C is the algae culture biomass concentration (in g_{DCW}·m⁻³);

L is the culture depth (in m) over which the photon flux balance is performed;

A_{SC}(λ) is the scatter-corrected algae culture absorbance (in AU) at a given λ;

σ(λ) is the algae culture absorption cross section (in m²·g_{DCW}⁻¹) at a given λ.

Combining Equations 28 and 29 yields:

$${A}_{SC}^{PAR} = {\sum }_{λ = 400}^{700} {P}_{LIGHT} ( λ ) \cdot {A}_{SC} ( λ ) \qquad Equation 30$$

wherein

A_{SC}^{PAR} is the overall scatter-corrected (SC) absorbance over the PAR spectrum (in Absorbance Units or AU);

P_{LIGHT} is the wavelength-dependent photon fraction (dimensionless) of the light source, determined from Equation 17;

A_{SC}(λ) is the scatter-corrected algae culture absorbance (in AU) at a given λ.

Description of the overall fraction of the light absorbed over the PAR spectrum by a given algal culture can be performed by defining an algae-specific PAR spectrum absorption coefficient, σ, as follows:

$$σ = \frac{ln 10 \cdot {A}_{SC}^{PAR}}{C \cdot L} \qquad Equation 31$$

wherein

σ is the algae-specific absorption cross section (in m²·g_{DCW}⁻¹);

A_{SC}^{PAR} is the overall scatter-corrected (SC) absorbance over the PAR spectrum (in Absorbance Units or AU);

C is the algae culture biomass concentration (in g_{DCW}·m⁻³);

L is the culture depth (in m) over which the photon absorption is evaluated.

The Equation 32 below, obtained from combining Equations 30 and 31, shows that the algae-specific absorption cross section, σ, which enables the use of Beer's law to describe the fraction of the light absorbed by an algae culture, can be determined experimentally. Indeed, the normalized light spectrum can be acquired using a spectrometer, and the scatter-corrected algae-culture spectrum can be obtained using a spectrophotometer as described by Ferrari et al. (supra). Equation 32 also shows that the algae-specific absorption cross section, σ, is also dependent upon the light source (LS) spectrum of the light illuminating the algae sample. Hence, σ, the algae-specific light spectrum-dependent absorption cross section, is determined at an algae concentration C_{E}, in a cuvette of depth L_{CUVETTE}, according to the formula:

$${σ}^{LS} = \frac{ln 10}{{C}_{E} \cdot {L}_{CUVETTE}} \cdot {\sum }_{λ = 400}^{700} {P}_{LIGHT} ( λ ) \cdot {A}_{SC} ( λ ) \qquad Equation 32$$

wherein

λ is a wavelength (in nm) in the PAR region (400-700 nm);

L_{CUVETTE} is the pathlength of the light through the spectrophotometer cuvette (in m);

C_{E} is the algae biomass concentration (in g_{DCW}·m⁻³) at which the absorbance spectra are evaluated;

P_{LIGHT} is the wavelength-dependent photon fraction (dimensionless) of the light source, determined according to Equation 17;

A_{SC}(λ) is the Scatter-Corrected (SC) culture absorbance spectrum, determined according to Equation 16;

thereby determining the algae-specific light source (LS)-dependent absorption cross section σ^{LS} (in m²·g_{DCW}⁻¹).

Determination of σ^{LS}, assumed to be constant throughout growth, enables the use of Beer's law to estimate the overall fraction of light transmitted through the algae culture, according to the formula:

I_{TRANSMITTED}(C)=I₀·exp(−σ^{LS}·C·L) Equation 33

wherein

I₀ is the incident photon flux density onto the algae culture (in μE·m⁻²·s⁻¹);

σ^{LS} is the algae-specific light source (LS)-dependent absorption cross section (in m²·g_{DCW}⁻¹);

C is the algae biomass concentration (in g_{DCW}·m⁻³) at which the fraction of light transmitted is evaluated;

L is the algae culture depth through which light is transmitted;

thereby calculating I_{TRANSMITTED}, the photon flux transmitted through the algae culture of concentration C and depth L.

The Equation 19 naturally stems from Equation 33. An interesting consequence of the spectral convolution between the scatter-corrected algae absorbance spectrum and the light emission spectrum (Equation 32) to evaluate σ^{LS}, the algae-specific light source (LS)-dependent absorption cross section, is that the fraction of light absorbed by the algae sample depends on both the light source (LS) under consideration and the spectral characteristics of the algae culture under consideration.

Autotrophic Yield Estimate from Algal Batch Growth Behavior by Modification of the Williams Equation to Display the Algae-Specific Light Source-Dependent Absorption Cross Section

The accuracy of the Williams model (see Ragonese et al., supra) requires estimation of a scatter-corrected absorption coefficient. Indeed, elastic scattering on whole algae cells does not incur energy loss, and the scattered photon can be used by the algal culture for photosynthesis. Estimation of the culture extinction using the Duarte coefficient as described above may be a suitable approximation for most cultures under nutrients-rich conditions. However, the use of this coefficient may not reflect adequately the distinctive or variable pigment compositions in certain algae cultures, and thus may introduce a significant error in the resulting productivity estimate. The following methods for calculating autotrophic yield may address varying spectral properties of different algae strains, which may diverge in different phyla from known spectral properties of other algal phyla or which may occur as a response to stresses.

In one embodiment, a third method for calculating the autotrophic yield is provided. This method uses the Ragonese and Williams model (supra) and the growth conditions described above (nutrients-replete conditions, CAM), with the added benefits of an experimentally determined the algae-specific light source-dependent absorption cross section. The autotrophic yield Φ^{DCW} (g_{DCW}/μE_{ABSORBED}), which is determined using the calculations and measurements described below is referred to as the Williams-Ferrari-Holland (WFH) autotrophic yield (Φ^{DCW,WFH})(g_{DCW}/μE_{ABSORBED}).

The ability to evaluate the amount of light absorbed by an algae culture, using Equation 19, upon determination of σ^{LS} and the incident PPFD I₀, enables the establishment of an alternative form of the Williams equation, which is most specific to the experimental conditions under consideration (light-source in use and algae culture spectral properties). Also provided herein is a method for determining the Williams-Ferrari-Holland autotrophic yield Φ^{DCW,WFH}, of an algal culture that comprises a plurality of algal cells in a liquid algal growth medium, the method comprising: (a) measuring the time t in hours (h) at a plurality of time points along the growth curve of the algal culture, wherein the time t is adjusted to reflect the time (e.g., number of hours) of light exposure; thus, the total culture time is reduced by the time (e.g., hours) when the cultures are in dark phase; (b) at each time t, determining the algal culture absorbance A(t) of a sample of the algal cells (i.e., to obtain A(t)₁ at t₁, A(t)₂ at t₂, and A(t)₃ at t₃ for each time point t₁₋ₙ, wherein n is any integer) to provide a growth curve; (c) estimating from the growth curve determined in (b) the corresponding algal biomass concentration C(t), using an experimentally determined correlation between absorbance and biomass concentration, k_{abs}, which is assumed to be constant throughout growth of the algal culture; (d) measuring the incident Photosynthesis Photon Flux Density I₀ (PPFD), in μE_{INCIDENT}·m⁻²·s⁻¹ for example, using a quantum meter, wherein 1 Einstein (E) designates 1 mole of photons in the Photosynthetically Active Radiation (PAR) region in the 400-700 nm range; (e) calculating the light spectrum-dependent algae-specific scatter-corrected absorption cross section, σ^{LS}, which is assumed to be constant throughout growth of the algal culture, as detailed above; (f) determining the Williams-Ferrari-Holland autotrophic yield Φ^{DCW,WFH} of the algal culture, from a linear interpolation, according to the formula:

$$\frac{L}{{I}_{0}} \cdot \{ \begin{matrix}C - {C}_{0} + \frac{1}{{σ}^{LS} \cdot L} \cdot \\ ln [ \frac{( 1 - exp ( - {σ}^{LS} \cdot L \cdot C ) )}{( 1 - exp ( - {σ}^{LS} \cdot L \cdot {C}_{0} ) )} ]\end{matrix} \} = {Φ}^{DCW , WFH} \cdot t \qquad Equation 34$$

wherein
t is the time (in hr) that the algal culture is in light phase (i.e., duration in the light phase in h);
C is the algae culture biomass concentration (in g_{DCW}·m⁻³) at time t;
C₀ is the algae culture biomass concentration (in g_{DCW}·m⁻³) at the inoculation time t₀=0;
I₀ is the incident Photosynthesis Photon Flux Density (in μE_{INCIDENT}·m⁻²·h⁻¹);
L is the depth of the culture (culture volume (m³)/area exposed to incident light (m²));
σ^{LS} is the algae-specific LS-dependent absorption cross section (in m²·g_{DCW}⁻¹), thereby calculating the Williams-Ferrari-Holland autotrophic yield Φ^{DCW,WFH} (in g_{DCW}/μE_{ABSORBED}).

### Corollaries to the Determination of the Algae Culture Autotrophic Yield Φ^{DCW} and Estimation of the Flux of Absorbed Photons

The consistency between the three methods presented for the calculation of the intrinsic nutrients-replete autotrophic yields Φ^{DCW} (Exponential-to-Linear Transition, Williams-Duarte, Williams, Ferrari-Holland) is supported by the results presented in Example 5. Hence, any of these methods is satisfactory for the estimate of the algae culture autotrophic yields Φ^{DCW} (g_{DCW}/μE_{ABSORBED}).

Corollary #1

To-date, attempts at parametrizing algae growth in bioreactors has been limited by the inability to easily estimate the algal concentration dependent fraction of absorbed photons (see, e.g., Aiba, “Growth kinetics of photosynthetic microorganisms,” p. 85-156, in Microbial Reactions; Barbosa et al., Biotechnology and Bioengineering 89:233-42 (2005); Koizumi et al., Appl. Microbiol. Biotechnol. 10:113-23 (1980)).

Biological productivity as an amount of biomass produced per area per time is the definition used in Equations 1, 2 (above) and Equation 35 (below). Productivity, defined as biological productivity and as area biomass production rate, describes the same reality and are therefore interchangeable.

In another embodiment, a method is provided to estimate rate of biomass fixation in a continuous bioreactor. Combining Equations 2 and 19 leads to the following light source (LS)-dependent algae-specific estimate of the area biomass production rate, or productivity, according to the formula:

P_{DCW}^{LSi}=Φ^{DCW}·I₀·[1−exp(σ^{LSi}·L·C] Equation 35

wherein

Φ^{DCW} is the algae culture autotrophic biomass yield (in g_{DCW}/μE_{ABSORBED});

I₀ is the incident Photosynthesis Photon Flux Density (in μE_{INCIDENT}·m⁻²·h⁻¹);

σ^{LSi} is the algae-specific light source i (LSi)-dependent absorption cross section (in m²·g_{DCW}⁻);

L is the depth of the culture (culture volume (m³)/area exposed to incident light (m²));

C is the algae culture biomass concentration (in g_{DCW}·m⁻³) which absorbs light;

thereby determining P_{DCW}^{LSi}, the algae-specific Light Source i (LSi)-dependent area productivity (in g_{DCW}·m⁻²·d⁻¹).

Equation 35 represents the missing equation for complete parametrization of continuous algae bioreactors. This, in-turn, enables establishment of a control system to ensure complete consumption of the nutrients feed and establish an environment of controlled nutrient-depletion.

Corollary #2

In another embodiment, a method is provided for comparing area biomass productivity of an algal culture exposed to each of two or more different light sources. In certain embodiments, the method permits determination of whether algae grown under artificial light would display a significant difference area biomass productivity when cultured outdoors due to the spectrum differences between a laboratory lighting system (e.g., for small batch algal culture) and sunlight (e.g., used for large scale biomass production).

The autotrophic yield Φ^{DCW} is a property independent of the light source, as it is implicitly assumed that all absorbed photons are utilized for biomass production with an equal efficiency. However, from a given light source, the amount of light absorbed for a given light intensity I₀ (μE·m⁻²·s⁻¹) will depend on both the algae scatter-corrected absorbance spectrum and the normalized incident light spectrum. This, in-turn, will affect the observed productivity.

Hence, given Equation 35, assuming the same incident PPFD I₀ for both light source 1 (e.g., the indoor fluorescent lighting) and light source 2 (e.g., the sunlight), the biomass productivity under LS2 can be determined from a known productivity under LS1 by accounting for spectral differences between LS1 and LS2, as follows:

$${P}_{DCW}^{LS 2} = {P}_{DCW}^{LS 1} \cdot \frac{1 - exp ( - C \cdot L \cdot {σ}^{LS 2} )}{1 - exp ( - C \cdot L \cdot {σ}^{LS 1} )} \qquad Equation 36$$

wherein

σ^{LSi} is the algae-specific light source i (LSi)-dependent absorption cross section (in m²·g_{DCW}⁻¹);

L is the depth of the culture (culture volume (m³)/area exposed to incident light (m²));

C is the algae culture biomass concentration (in g_{DCW}·m⁻³) which absorbs light;

P_{DCW}^{LS1} is the known (or estimated) algae-specific Light Source 1 (LS1)-dependent area productivity (in g_{DCW}·m⁻²·d⁻¹);

thereby determining P_{DCW}^{LS2}, the algae-specific Light Source 2 (LS2)-dependent area productivity (in g_{DCW}·m⁻²·d⁻¹).

Hence, for a given incident photon flux density I₀, the area biomass productivity will differ only if some light is transmitted through the algae bioreactor. Differences in LS1 and LS2 spectra can be compensated for, to some extent, by increasing the algae concentration C and/or the bioreactor depth L.

Morel et al. (Limnol. Oceanog. 32:1066-84 (1987)) have addressed the influence of the incident light spectrum on the algae biomass productivity by defining a Photosynthetically Usable Radiation (PUR) from the measured Photosynthetically Active Radiation (PAR, all photons in the 400 nm-700 nm range). However, this method uses the algae raw absorption spectrum to normalize the incident light spectrum (see Eq. 8, Morel et al., supra), which may introduce systematic errors because scattered photons are not lost for photosynthesis.

In certain embodiments of the methods and analyses described above, the methods are practiced using computers and software to accomplish one or more of the analyses described. For example, for the step of determining photosynthetic efficiency and/or determining a photosynthetic efficiency correction factor, the methods further comprise performing the calculation(s) according to the respective formulas using a computer device comprising a computer readable program for performing the calculation(s). A computer readable program includes a computer usable storage medium having computer readable program code means embodied in the medium.

In certain embodiments of the methods described above and herein for the step of determining photosynthetic efficiency and/or determining a photosynthetic efficiency correction factor, the methods further comprise performing the calculation(s) according to the respective formulas using a computer comprising a computer readable program for performing the calculation(s).

### Algal Growth Media and Growth Conditions

Provided herein are formulations for algal growth media that may be used for various algal strains. In one embodiment, a media composition is provided that is used for culturing freshwater algal species. In other embodiments, media compositions are provided for culturing saltwater species that have varying concentrations of major salts.

Algal growth media recipes that are presently available contain undefined components such as soil water extract, seawater, tryptone or yeast extract (see, e.g., website utex.org), and are highly specific to each algal strain and its preferred ionic strength. The presence of these undefined components can render physiological characterization difficult and can interfere with establishment of a controlled large-scale production environment. The use of a constant nutrient recipe while varying the ionic strength of the major ionic species has been developed for non-freshwater species (Georgia Ten, University of Hawaii NREL culture collection curator), but has not been developed for freshwater algal species. Type II medium preparation, widely used in the NREL studies (see, e.g., Sheehan et al. (1998) A Look Back at the U.S. Department of Energy's Aquatic Species Program—Biodiesel from Algae. National Renewable Energy Laboratory) proved to be very cumbersome. Accordingly, a fully defined algal culture media referred to herein as FLX media (see Table I, Example 1) has been prepared that reflects a range of ionic strengths by varying major salt concentration (e.g., sodium chloride, magnesium chloride, potassium chloride, calcium chloride, and magnesium sulfate) while keeping a constant nutrients base composition (including vitamins and micronutrients). FLX1 (see Table I, Example 1) corresponds to a freshwater recipe.

A linear interpolation of the major salt concentrations between FLX10 and FLX100 (see Table I, Example 1), which respectively correspond to 10% and 100% of seawater ionic strength, can be prepared to comprise any intermediate salinity. Lower calcium concentrations were chosen to limit aggregation of the cells (see, e.g., Straley et al., Plant Physiol. 63:1175-81 (1979)). As compared to artificial seawater media (see utex.org, supra), sulfate concentration was lowered to 2 mM in higher salinity media to limit interference in the case of anaerobic digestion of algal biomass for methane production (see, e.g., Isa et al., Appl. Environ. Microbiol. 51:572-79 (1986)). The medium formulation (see Table I, Example 1) was adjusted to ensure no nutrient limitation during growth of algal cells harvested at a concentration in the order of 0.14-0.38 mg/mL. The nitrogen concentration represents, at most, 12% of the DCW (see, e.g., Kroon et al. J. Phycol. 42:593-609 (2006)) and was adjusted to 5 mM N or 0.069 mg-N/mL. This shows that the various uptake systems were not induced sequentially, but were operating in parallel in most cases. The phosphorus concentration, with a typical cellular molar ratio of 1:16 P:N (Ho (2006) “The trace metal composition of marine microalgae in cultures and natural assemblages” In Algal cultures analogues of blooms and applications (see, e.g., Rao, ed.). pp. 271-299)), was adjusted to an excess of 0.3 mM as free phosphate. Iron and vitamins, which are commonly limiting in the environment (see, e.g., Wells et al., Mar. Chem. 48:157-82 (1995); Cole, Ann. Rev. Ecol. Syst. 13:291-314 (1982)), were added in excess. The iron source, provided as freshly added citrate-chelated iron III (see Table I, Example 1), was chosen for its ability to support excellent growth in the bacterium Deinococcus radiodurans, shown to need high concentrations of soluble iron (see, e.g., Holland et al. Appl. Microbiol. Biotechnol. 72:1074-82 (2006)). Culture times, temperature, light source, and other growth conditions for propagation of algal cells may be determined readily by a person skilled in the art given the methods described herein and practiced in the art. Exemplary growth conditions for algal cultures are provided in the examples.

Reports indicate that more than 14,000 algae species exist. Algal strains for selection studies include any of hundreds of freshwater or salt water species available to a person skilled in the relevant art. The algal strains may be chosen from strains that are presently used for research or commercial purposes or may be newly isolated from the environment. Exemplary classes of algae are described herein and are known in the art. A benefit of isolating populations of algae from the environment is the possible co-isolation and maintenance of symbiotic bacteria that stimulate growth and prevent heterotroph invasion (see, e.g., Banerjee et al., Crit. Rev. Biotechnol. 22:245-79 (2002); de Bashan et al., Water Res. 38:466-74 (2004)). Environmental populations can be characterized and compared to unialgal cultures, which display consistent behaviors. These cultures using algal strains obtained from the environment may provide additional robustness against contamination due to their initial ability to out-compete organisms co-isolated from the environment.

### EXAMPLES

For background, see generally Biofuels (Advances in Biochemical Engineering/Biotechnology, Lisbeth Olsson ed. (2007)); Aiba, “Growth Kinetics of Photosynthetic Organisms” in Advances in Microbial Reactions (Volume 23 of Biochemical Engineering/Biotechnology Series, Springer Berlin, Heidelberg (1982)) pages 85-156.

### Example 1

### Determination of the Exponential-to-Linear Transition Autotrophic Yield Φ^{DCW,ELT} In Aerated Algae Cultures Under Nutrients-Replete Conditions

### Cultures Origins and Growth Conditions

The FLX media recipes are detailed in Table I.

TABLE I
FLX growth media recipe

| | | FINAL | | | |
|---|---|---|---|---|---|
| | | CONCENTRATION IN MM | | | |
| STOCK SOLUTIONS | STERILIZATION | FLX1 | FLX10 | FLX50 | FLX100 |
| NaCl | AUTOCLAVED | 25 | 48 | 240 | 480 |
| MgCl₂ | AUTOCLAVED | 1 | 5.6 | 23 | 56 |
| KCl | AUTOCLAVED | 1 | 1 | 5 | 10 |
| CaCl₂ | AUTOCLAVED | 0.2 | 0.2 | 1 | 2 |
| MgSO₄ | AUTOCLAVED | 0.3 | 0.3 | 2 | 2 |

| | | |
|---|---|---|
| TRIS PH 7.6 | AUTOCLAVED | 10 |
| VITAMINS¹ | 0.22 μM FILTER | SEE BELOW |
| MICRONUTRIENTS² | 0.22 μM FILTER | SEE BELOW |
| IRON III³ | 0.22 μM FILTER | 0.010 (ADDED FRESH UPON |
| | | INOCULATION) |
| Na₂SiO₃ | 0.22 μM FILTER | 0.2 (FOR |
| | | BACILLARIOPHYCEAE ONLY) |
| NaH₂PO₄ | AUTOCLAVED | 0.3 |
| NaNO₃ | AUTOCLAVED | 3 |
| NH₄Cl | | 2 |

¹Vitamins, final concentration in ng/L: thiamine 67, biotin 0.25, vitamin B₁₂ 15
²Micronutrients, final concentration in μM: ZnSO₄ 0.8, MnCl₂ 0.9, Na₂MoO₄ 0.026, CoCl₂ 0.042, CuSO₄ 0.039, Na₂EDTA 50, H₃BO₃ 100
³The iron III was supplied upon inoculation as a FeCl₃:Sodium citrate 1:3 stock (molar ratio)

The algae cultures investigated are listed in Table II. As handled, all cultures showed the presence of bacteria, which was tested in rich undefined medium (Cho et al., J. Appl. Phycol., 14, 385 (2002)). The environmental populations JalxC, Cs, JalxD and JalxE were collected in August 2006 from freshwater lake and stagnant water environments in areas near Monroe, Wash., USA (47° 51′ N, −121° 58′ W). JalxC, Cs and JalxE were transferred several times to FLX1 supplemented with anaerobic digester (AD) effluent, used as the N/P source to a final concentration of 750 μM ammonium and 50 μM phosphorus. The AD effluent was collected from the Vander Haak dairy farm mesophilic digester in Lynden, Wash., USA (48° 56′ N, −122° 27′ W). JalxD was continuously transferred on FLX1. The other algae cultures were unialgal and ordered from various sources (Table II).

TABLE II
Identification, source and growth medium for the strains investigated

| | GROWTH | | | |
|---|---|---|---|---|
| ABBREV. | MEDIUM¹ | SPECIES | CLASS | SOURCE²⁻⁴ |
| JALXC | FLX1 | NOT DETERMINED | | ENV. |
| | | | | SAMPLES² |
| CS | FLX1 | NOT DETERMINED | | ENV. |
| | | | | SAMPLES² |
| JALXD | FLX1 | NOT DETERMINED | | ENV. |
| | | | | SAMPLES² |
| JALXE | FLX1 | NOT DETERMINED | | ENV. |
| | | | | SAMPLES² |
| SE | FLX1 | NEOCHLORIS | CHLOROPHYCEAE | UTEX³ 1185 |
| | | OLEOABUNDANS | | |
| MON | FLX1 | MONORAPHIDIUM | CHLOROPHYCEAE | NREL⁴ |
| | | SP. | | MONOR01 |
| PR2 | FLX1 | ANKISTRODESMUS | CHLOROPHYCEAE | UTEX 189 |
| | | ANGUSTUS | | |
| PR5 | FLX1 | KIRCHNERIELLA | CHLOROPHYCEAE | UTEX 285 |
| | | LUNARIS | | |
| PR6 | FLX1 | SELENASTRUM | CHLOROPHYCEAE | UTEX 326 |
| | | MINUTUM | | |
| FRA | FLX10 | FRANCEIA SP. | CHLOROPHYCEAE | NREL |
| | | | | FRANC01 |
| E1 | FLX100 | DUNALIELLA | CHLOROPHYCEAE | UTEX LB |
| | | PRIMOLECTA | | 1000 |
| | FLX100 | CHAETOCEROS | BACILLARIOPHYCEAE | UTEX LB |
| | | GRACILIS | | 2658 |
| | | SCHÜTT | | |
| | FLX50 | CYCLOTELLA SP. | BACILLARIOPHYCEAE | UTEX 1269 |
| | FLX100 | PHAEODACTYLUM | BACILLARIOPHYCEAE | UTEX 646 |
| | | TRICORNUTUM | | |
| | FLX1 | NANNOCHLORIS SP. | CHLOROPHYCEAE | UTEX LB |
| | | | | 2291 |
| | FLX1 | ANKISTRODESMUS | CHLOROPHYCEAE | UTEX 188 |
| | | ANGUSTUS | | |
| | | BERNARD | | |
| | FLX1 | ANKISTRODESMUS | CHLOROPHYCEAE | UTEX 241 |
| | | ANGUSTUS | | |
| | | BERNARD | | |
| | FLX1 | ANKISTRODESMUS | CHLOROPHYCEAE | UTEX 242 |
| | | FALCATUS | | |
| | FLX10 | NAVICULA | BACILLARIOPHYCEAE | NREL |
| | | SAPROPHILA | | NAVIC02 |
| | FLX100 | NITZSCHIA | BACILLARIOPHYCEAE | NREL |
| | | PUSILLA | | NITZS12 |

¹See Table I.
²Environmental samples: see Method for details
³UTEX cultures were ordered from the University of Texas collection (see University of Texas (utex) web site (.org))
⁴NREL cultures were ordered form the SERI/NREL collection maintained at the University of Hawaii Center for Marine Microbial Ecology & Diversity (Kevin Kelly,). The strains name and origin are detailed elsewhere (Sheehan et al. 1998).

The 100 mL-cultures were grown at 24±1° C. in 250 mL Erlenmeyer flasks with an 88 mm base diameter, capped with silicon sponge closures (Bellco Biotechnology, Inc.), on a rotating platform shaking at 120 rpm, with a 16:8 h Light:Dark cycle. An array of cool white fluorescent lamps, fixed above the shaking platform for lighting, yielded a homogeneous light intensity in the order of 35-65 μE/m²/s. Incident light intensities were measured for each culture in the 400-700 nm range (Photosynthetically Active Radiation) with a quantum meter (AgriHouse Inc.). For characterization, batch cultures were grown in triplicate consecutive cultures with a 50- to 100-fold diluted inoculum.

### Analytical Methods

For each culture, optical density at 680 nm (A₆₈₀) was measured using a Beckman spectrophotometer for a growth period of 5-6 days. All other assays were performed at the time of harvest. Error bars represent standard deviations (SD) for the triplicate cultures. Culture pH was measured with a compact pH meter (Horiba, Japan).

For gravimetric analyses, unless otherwise mentioned, single-use concave boats (0.3-0.6 g) were made using heavy duty aluminum foil lined with glass fiber filters (Millipore). For lipid extraction and boat DCW determination, 40 mL samples were pelleted in 50 mL conical tubes by centrifugation at 5,000 rpm at room temperature for 5 min, resuspended in medium to allow transfer into 1.5 mL screw-cap tubes, pelleted at 14,000 rpm for 2 min before careful removal of the supernatant. Pellets were frozen at −80° C. until analysis.

For the Dry Cell Weight (DCW) determination, the harvested pellets were first resuspended in 300-400 μL water and subsequently applied onto pre-dried and pre-weighed concave boats. Boats were dried or pre-dried 4-7 days at 65-70° C. to constant weight, and weighed within a 0.1 mg precision after 1-2 h sample equilibration to room temperature.

The boat DCW method was used to correlate A₆₈₀ and DCW concentration for each culture, as shown in Table III.

TABLE III
Values for k_{abs}, correlating A₆₈₀ and the biomass concentration at the time of harvest

| CULTURE | JALXC | JALXD | JALXE | SE | MON | PR2 | PR5 | PR6 | FRA | E1 |
|---|---|---|---|---|---|---|---|---|---|---|
| AVG.¹ | 177 | 178 | 187 | 212 | 198 | 192 | 211 | 235 | 309 | 414 |
| SD² | 8 | 15 | 18 | 5 | 9 | 3 | 7 | 28 | 21 | 57 |
| RSD³ | 4.5 | 8.6 | 9.8 | 2.3 | 4.7 | 1.7 | 3.2 | 12.0 | 6.9 | 13.8 |

¹Average correlation (triplicate consecutive cultures) in g_{DCW}/m³/A₆₈₀
²Standard deviation (triplicate consecutive cultures) in g_{DCW}/m³/A₆₈₀
³Relative standard deviation (%). The interspecies average relative standard deviation is 6.8%.

### Results

The A₆₈₀ has been established as a consistent indicator of biomass concentration for each species, such that Equation 3 simplifies to, at constant volume:

$$\frac{d {A}_{680}}{d t} = μ \cdot {A}_{680} ,$$

which enables the determination of the growth rate μ from an exponential fit of the A₆₈₀(t) curve.

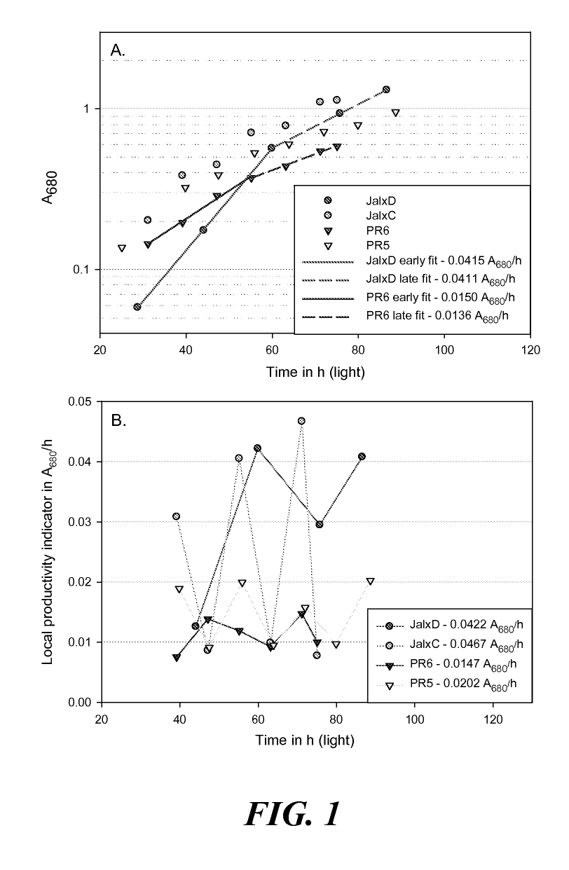

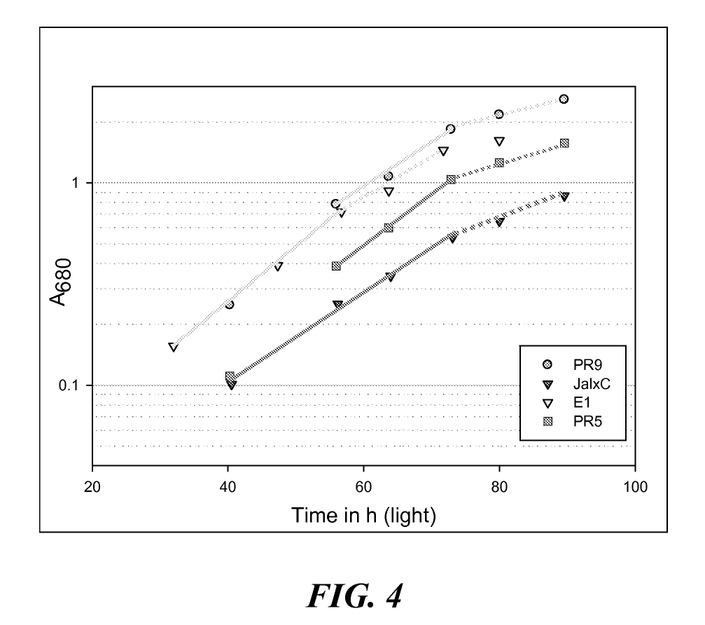

Aerated algal growth curves (see FIG. 1A) were used for the determination of the autotrophic yield. The culture time in the dark has been truncated from the time scale to reveal the truly exponential behavior of the growth, particularly apparent in JalxD and PR6 (FIG. 1A). In the case of a perfect exponential behavior for three or more points (JalxD and PR6, FIG. 1A), the growth rate μ (in h⁻¹) was calculated from the exponential fit. The corresponding fitted productivity indicator (FPI) A₆₈₀·μ was calculated from the fitted rate μ and the corresponding A₆₈₀ taken at the latest time point. For a given growth curve, the highest FPI value was retained for the culture maximum Φ^{DCW} estimate. As an example, for both JalxD and PR6, the highest FPI (0.0415 and 0.0150 A₆₈₀/h for JalxD and PR6 respectively) were taken from exponential fits in the earlier part of the curve (solid line), since the later part of the curves (dashed lines) have lower A₆₈₀·μ values, as reported in the legend. However, a ‘stair-like’ behavior (JalxC and PR5, FIG. 4A) was observed most often in the tested cultures. This behavior resulted from higher local growth rates when the light period was interrupted by a dark phase, compared to a lower rate when the growth period was under continuous illumination. For this reason, a local productivity indicator (LPI) A₆₈₀·μ was evaluated as above between each time point pairs (FIG. 1B). The highest LPI value, shown in the FIG. 1B legend, was used to estimate the culture maximum Φ^{DCW} estimate. As detailed above, the LPI-underlying discrete exponential approximation should yield on average a good estimate for the culture maximum Φ^{DCW}. Notably, the FPI and LPI methods are in close agreement for the cultures displaying good exponential behaviors (JalxD and PR6 in FIG. 1A).

From the k_{abs} values (Table III) and the LPI definition above, Equation 9 becomes:

$${Φ}^{DCW , ELT} = \frac{{LPI}_{ma x} \cdot {k}_{ab s} \cdot {V}_{C}}{{I}_{0} \cdot {A}_{C}}$$

The practical significance of the determined Φ^{DCW,ELT} is revealed by reporting corresponding maximum area productivities, according to Equation 1:

P_{DCW}^{MAX}=Φ^{DCW}·I₀

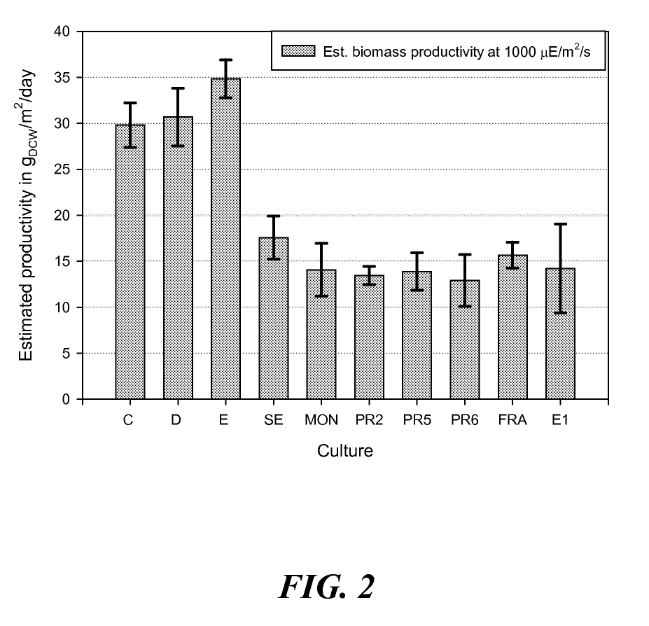

assuming an average incident PPFD I₀ of 1000 μE_{INCIDENT}·m⁻²·s⁻¹. This value was chosen as a representative average of yearly levels measured in Arizona, assuming a 12 h-day (Kania et al., ag.arizona.edu/CEAC/research/archive/solar-radiation_kania.pdf). Estimated maximum area productivities corresponding to the experimentally determined Φ^{DCW,ELT} are reported in FIG. 2. Such data could be used to select the JalxE algae culture for outdoor cultivation, due to its higher biomass autotrophic yield (or higher estimated maximum area productivity).

These estimated productivities (15-35 g·m⁻²·d⁻¹) in nutrients-replete aerated batch cultures were consistent with published data for outdoor cultivation at comparable latitudes (Capo, Jaramillo et al. 1999; Journal of Applied Phycology 11(2): 143). However, the ‘stair-like’ growth behavior (FIG. 1A) suggested a possible limitation in dissolved inorganic carbon (abbreviated Ci, and designates dissolved CO₂ and ionic carbonate species). In addition, solving for the Ci concentration in equilibrium with air as a function of pH (FIG. 3) clearly showed that the desired mM range was achieved with difficulty in the neutrophilic range pH7-8.5 (black arrow FIG. 3).

### Example 2

### Growth Behavior for Carbonate-Amended Cultures and Determination of Heightened Autotrophic Yields

See Example 1 for cultures origins, growth conditions and analytical methods, with the following modifications: the nitrogen source supplied was 3 mM nitrate (not 3 mM nitrate and 2 mM ammonium as in Example 1), and the flask was sealed according to the Carbonate Addition Method (CAM) (not aerated as in Example 1). Sealing was performed by placing autoclaved aluminum foil over the flask aperture, which was then covered hermetically with PARAFILM.

Compared to the aerated cultures in FIG. 1, the algae cultures grown using CAM displayed perfect exponential growth behaviors as shown in FIG. 4, where the light/dark dependent ‘stair-like’ behavior (see FIG. 1) was alleviated. This perfect exponential behavior for each culture (either early exponential, solid line, or late exponential, hatched line) allowed for the determination of the early Fitted Productivity Estimate (FPI, defined in Example 1) and the late FPI. The maximum FPI (early or late exponential) was used for the CAM autotrophic yield Φ^{DCW,ELT}, according to the formula:

$${Φ}^{DCW , ELT} = \frac{{FPI}_{m ax} \cdot {k}_{ab s} \cdot {V}_{C}}{{I}_{0} \cdot {A}_{C}}$$

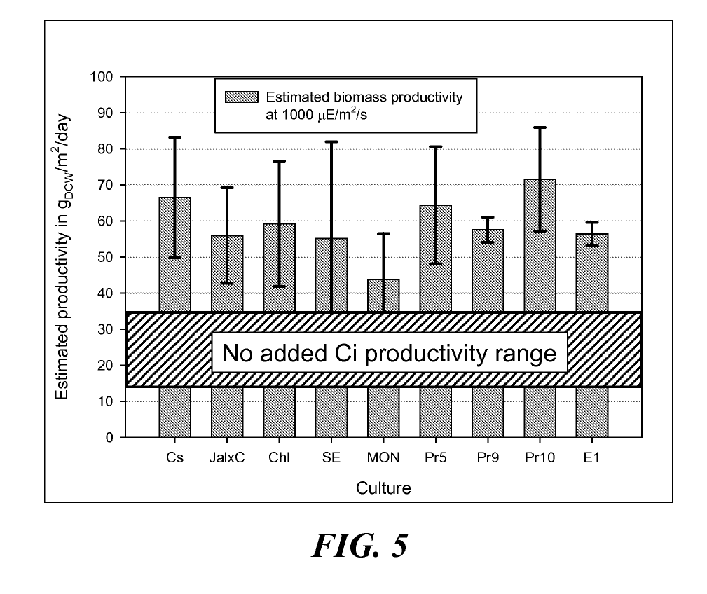

In addition, the corresponding determined autotrophic yields Φ^{DCW,ELT} using CAM, reported as the corresponding P_{DCW}^{MAX} (See Example 1), were significantly higher (see FIG. 5). Indeed, productivity estimates from CAM cultures were in the 45-75 g·m⁻²·d⁻¹ range (FIG. 5), while those from aerated batch growth behaviors were in the 15-35 g·m⁻²·d⁻¹ range (see FIG. 2). Hence, the Carbonate Addition Method successfully alleviated dissolved inorganic carbon limitations, which is responsible for an early plateau in aerated batch growth behaviors. Hence, CAM enables a much more accurate estimate of the autotrophic culture intrinsic yield Φ^{DCW, ELT}.

### Example 3

### Determination of the Williams-Duarte Autotrophic Yield Φ^{DCW,WD}

See Example 1 for cultures origins, growth conditions, and analytical methods, with the following modifications: the nitrogen source supplied was 3 mM nitrate (not 3 mM nitrate and 2 mM ammonium as in Example 1), and the flask was sealed according to the Carbonate Addition Method (CAM) as described in Example 2 (i.e., not aerated as in Example 1).

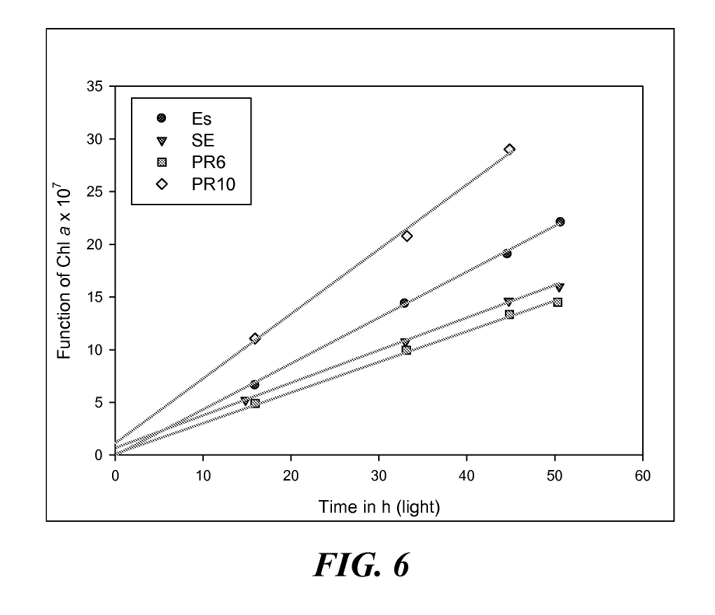

In order to test the validity of the Williams model modified to reflect the use of the Duarte chlorophyll-specific autotrophic extinction coefficient, the Left-Hand Side of Equation 14 was plotted as a function of time (see FIG. 6) for four algae cultures grown in nutrients-replete, carbonate-amended conditions. The slope corresponds to Φ^{Ch1} (g Ch1/μE_{ABSORBED}), from which Φ^{DCW, WD} can be estimated using Equation 15. As expected from Equation 14, the function describes a straight line for all cultures. Non-zero intercepts, observed for some cultures, may reflect physiological changes upon inoculation at the reference time. As added advantages, the growth behavior does not need to reach the Exponential-to-Linear Transition for determination of the autotrophic yield Φ^{DCW, WD} (g_{DCW}/μE_{ABSORBED}), and the fraction of absorbed photons is estimated from the known incident light levels using Beer's law.

### Example 4

### Determination of the Williams-Ferrari-Holland Autotrophic Yield Φ^{DCW,WFH}

See Example 1 for cultures origins, growth conditions and analytical methods, with the following modifications: the nitrogen source supplied was 3 mM nitrate (not 3 mM nitrate and 2 mM ammonium as in Example 1), and the flask was sealed according to the Carbonate Addition Method (CAM) (see Example 2) (i.e., not aerated as in Example 1).

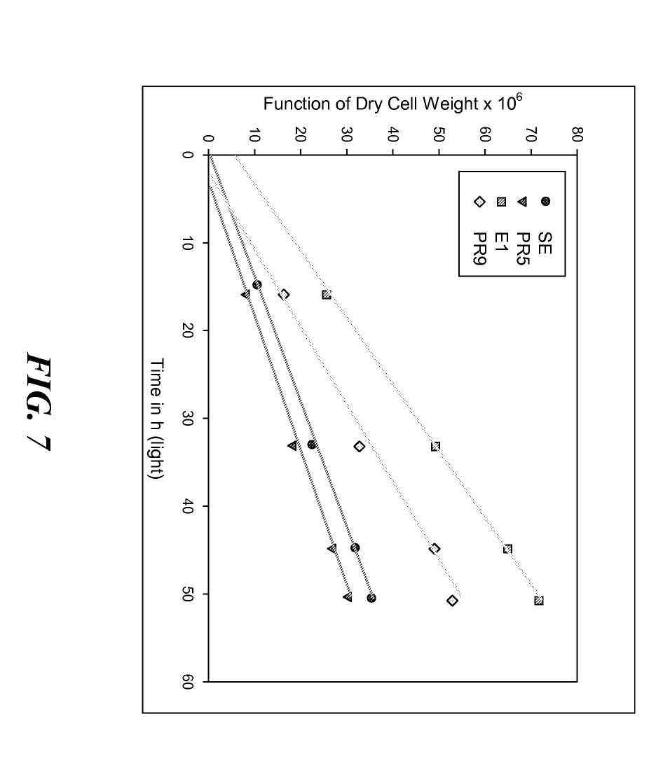

In order to test the validity of the Williams model, modified to reflect the use of the experimentally determined algae-specific light source-dependent absorption cross section σ^{LS} (Equation 32), the Left-Hand Side of the Equation 34 was plotted as a function of time (see FIG. 7) for four algae cultures grown in nutrients-replete, carbonate-amended conditions. The slope corresponds to Φ^{DCW, WFH} (g_{DCW}/μE_{ABSORBED}). As expected from Equation 34, the function describes a straight line for all cultures. As noted in Example 3, non-zero intercepts, observed for some cultures, may reflect physiological changes upon inoculation at the reference time. As added advantages, the growth behavior does not need to reach the Exponential-to-Linear Transition for determination of the autotrophic yield Φ^{DCW, WFH} (g_{DCW}/μE_{ABSORBED}), and the fraction of absorbed photons is estimated from the known incident light levels using Beer's law.

### Example 5

### Comparison Between Autotrophic Yields Φ^{DCW} Determined Using the Exponential-to-Linear Transition, Williams-Duarte and Williams-Ferrari-Holland Methods

See Example 1 for cultures origins, growth conditions and analytical methods, with the following modifications: the nitrogen source supplied was 3 mM nitrate (not 3 mM nitrate and 2 mM ammonium as in Example 1), and the flask was sealed according to the Carbonate Addition Method (CAM) (see Example 2) (i.e., not aerated as in Example 1).

The practical significance of the determined Φ^{DCW} is revealed by reporting corresponding maximum area productivities, according to Equation 1:

P_{DCW}^{MAX}=Φ^{DCW}·I₀

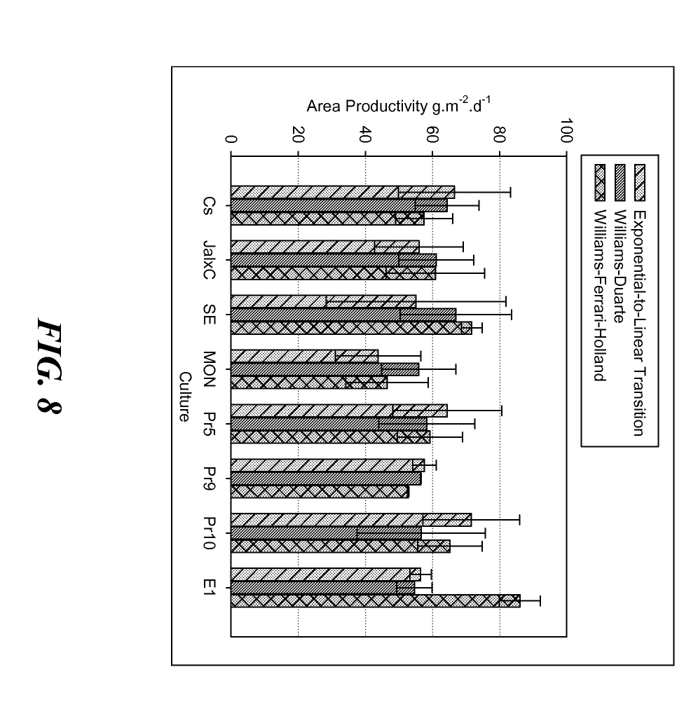

assuming an average incident PPFD I₀ of 1000 μE_{INCIDENT}·m⁻²·s⁻¹. This value was chosen as a representative average of yearly levels measured in Arizona, assuming a 12 h-day (Kania et al., ag.arizona.edu/CEAC/research/archive/solar-radiation_kania.pdf). For a given data set (triplicates), estimated maximum area productivities corresponding to the experimentally determined Φ^{DCW, ELT}, Φ^{DCW, WD}, and Φ^{DCW, WFH} are reported in FIG. 8. All three methods are consistent, such that any of these methods is satisfactory for estimating the algae culture autotrophic yields Φ^{DCW} (g_{DCW}/μE_{ABSORBED}), and corresponding P_{DCW}^{MAX} (g·m⁻²·d⁻¹) for measured levels of incident PPFD I₀.

All the above U.S. patents, U.S. patent application publications, U.S. patent applications, foreign patents, foreign patent applications, and non-patent publications referred to in this specification and/or listed in the Application Data Sheet, are incorporated herein by reference, in their entirety.

In general, in the following claims, the terms used should not be construed to limit the claims to the specific embodiments disclosed in the specification and the claims, but should be construed to include all possible embodiments along with the full scope of equivalents to which such claims are entitled. Those skilled in the art will recognize, or be able to ascertain, using no more than routine experimentation, many equivalents to the specific embodiments of the invention described herein. Such equivalents are intended to be encompassed by the following claims. Accordingly, the claims are not limited by the disclosure.

I claim the following:

1. A method for determining the Exponential-to-Linear Transition autotrophic yield Φ^{DCW,ELT} of or an algal culture that comprises a plurality of algal cells in a liquid algal growth medium, the method comprising:
(a) measuring time t in hours (h) at a plurality of time points during growth of the algal culture, wherein the time t is adjusted to reflect the time the algal culture is exposed to light;
(b) determining algal culture absorbance at each time t to provide a growth curve;
(c) estimating from the growth curve, the corresponding algal biomass concentration C(t), using an experimentally determined correlation between absorbance and biomass concentration, wherein the biomass concentration is assumed to be constant throughout growth of the algal cells;
(d) calculating the biomass production rate from the exponential growth behavior of C(t);
(e) determining the maximum biomass production rate from (d);
(f) determining the incident Photosynthesis Photon Flux Density I₀
(PPFD), in μE_{INCIDENT}·m⁻²·s⁻¹, wherein 1 Einstein (E) designates 1 mole of photons in the Photosynthetically Active Radiation (PAR) region in the 400-700 nm range; and
(g) calculating the Exponential-to-Linear Transition (ELT) autotrophic yield Φ^{DCW,ELT} of the algal culture according to the formula:
$${Φ}^{DCW , ELT} = \frac{{{V}_{C} \cdot \frac{d C}{d t} \vert}_{ma x}}{{I}_{0} \cdot {A}_{C}}$$
wherein
t is the time (in h) the algal culture is in the light phase;
I₀ is the incident Photosynthesis Photon Flux Density (in μE_{INCIDENT}·m⁻²·h⁻¹);
C(t) is the biomass concentration (in g_{DCW}·m⁻³) at time t;
V_{c} is the batch culture constant volume (in m³); and
A_{c} is the area of the culture perpendicular to the light source (in m²),
thereby calculating the ELT autotrophic yield Φ^{DCW,ELT} (in g_{DCW}/μE_{absorbed}).

2. A method for determining the Williams-Duarte autotrophic yield Φ^{DCW,WD} of an algal culture that comprises a plurality of algal cells in a liquid algal growth medium, the method comprising:
(a) measuring time t in hours (h) at a plurality of time points during growth of the algal culture, wherein the time t is adjusted to reflect the time the algal culture is exposed to light;
(b) at each time t, determining the algal culture absorbance A(t) to provide a growth curve;
(c) estimating from the growth curve, the corresponding algal biomass concentration C(t), using an experimentally determined correlation between absorbance and biomass concentration, k_{abs}, wherein k_{abs} is assumed to be constant throughout growth of the algal culture;
(d) estimating from (c) the corresponding chlorophyll concentration C_{ch1}(t), using an experimentally determined chlorophyll weight fraction, F_{Ch1}, wherein F_{Ch1} is assumed to be constant throughout growth, using the formula:
C_{Ch1}(t)=k_{abs}·F_{Ch1}·A(t)
wherein
t is the time the algal culture is in the light phase (in h);
A is the algae culture absorbance (in Absorbance Units or AU) at time t;
k_{abs} is the correlation between the absorbance and the biomass concentration (in g_{DCW}·m⁻³·AU⁻¹); and
F_{Ch1} is the chlorophyll weight fraction (in g_{Ch1}/g_{DCW}),
thereby calculating the chlorophyll concentration C_{Ch1} (in g_{Ch1}·h⁻³);
(e) determining the incident Photosynthesis Photon Flux Density I₀ (PPFD), in μE_{INCIDENT}·m⁻²·s⁻¹, wherein 1 Einstein (E) designates 1 mole of photons in the Photosynthetically Active Radiation (PAR) region in the 400-700 nm range;
(f) calculating the chlorophyll autotrophic yield Φ^{Ch1}, in g Ch1 α/μE_{ABSORBED}, from a linear interpolation, according to the formula:
$$\frac{L ( {C}_{Chl} ( t ) - {C}_{Chl} ( {t}_{0} ) )}{{I}_{0}} \cdot \{ \begin{matrix}1 + \frac{1}{{α}_{Chl} L ( {C}_{Chl} ( t ) - {C}_{Chl} ( {t}_{0} ) )} \cdot \\ ln [ \frac{( 1 - exp ( - {α}_{Chl} {LC}_{Chl} ( t ) ) )}{( 1 - exp ( - {α}_{Chl} {LC}_{Chl} ( {t}_{0} ) ) )} ]\end{matrix} \} = {Φ}^{Chl} \cdot t$$
wherein
t is the time (in h) the algal culture is in the light phase;
t₀ is the reference inoculation time (t₀=0 h);
C_{Ch1} is the chlorophyll concentration (in g_{Ch1}·m⁻³);
I₀ is the incident Photosynthesis Photon Flux Density (in μE_{INCIDENT}·m⁻²·h⁻¹);
L is the depth of the culture (culture volume (m³)/area exposed to incident light (m²)); and
α_{Ch1} is the chlorophyll specific autotrophic absorption, estimated to be 11.9 m²·g_{Ch}1⁻¹,
thereby calculating the chlorophyll-specific autotrophic yield Φ^{Ch1}, in g_{Ch1}/μE_{ABSORBED}; and
(g) assuming a constant chlorophyll weight fraction F_{Ch1}, calculating the Williams-Duarte autotrophic yield Φ^{DCW,WD} of the algal culture according to the formula:
$${Φ}^{DCW , WD} = \frac{{Φ}^{Chl}}{{F}_{Chl}}$$
wherein
Φ^{Ch1} is the chlorophyll-specific autotrophic yield (in g_{Ch1}/μE_{ABSORBED}); and
F_{Ch1} is the chlorophyll weight fraction (in g_{Ch1}/g_{DCW}),
thereby calculating the Williams-Duarte autotrophic yield Φ^{DCW,WD} (in g_{DCW}/μE_{ABSORBED}).

3. A method for determining the flux of photons absorbed I_{ABS}(C) by an algae culture of biomass concentration C, the method comprising:
(a) at a given culture biomass concentration C_{E}, determining spectrophotometrically the algae culture absorbance spectrum A_{RAW}(λ) of a sample of algal cells over the PAR region;
(b) performing discoloration of the algal cells to provide discolored algal cells, and at the given culture biomass concentration C_{E}, determining spectrophotometrically the algae culture absorbance spectrum A_{SCATTER}(λ) over the PAR region of the discolored algal cells;
(c) at the given culture biomass concentration C_{E}, calculating the scatter-corrected absorbance spectrum A_{SC}(λ) over the PAR region, according to the formula:
A_{SC}(λ)=A_{RAW}(λ)−A_{SCATTER}(λ)
wherein λ is a wavelength (in nm) in the PAR region (400-700 nm);
(d) spectrometrically acquiring the light source emission spectrum E_{LIGHT}(λ) (in count numbers as a function of λ, wherein count numbers are proportional to the number of photons emitted by the light source);
(e) normalizing the E_{LIGHT}(λ) spectrum over the PAR region, to evaluate the fraction of emitted photons at wavelength λ P_{LIGHT}(λ) according to the formula:
$${P}_{LIGHT} ( λ ) = \frac{{E}_{LIGHT} ( λ )}{{\sum }_{λ = 400}^{700} {E}_{LIGHT} ( λ )} ;$$
(f) at the given culture biomass concentration C_{E}, determining the light spectrum-dependent algae-specific scatter-corrected absorption cross section, σ^{LS}, wherein σ^{LS} is assumed constant throughout growth of the algal culture, according to the formula:
$${σ}^{LS} = \frac{ln 10}{{C}_{E} \cdot {L}_{CUVETTE}} \cdot {\sum }_{λ = 400}^{700} {P}_{LIGHT} ( λ ) \cdot {A}_{SC} ( λ )$$
wherein
λ is a wavelength (in nm) in the PAR region (400-700 nm);
L_{CUVETTE} is the pathlength of the light through the spectrophotometer cuvette (in m);
C_{E} is the algae biomass concentration (in g_{DCW}·m⁻³) at which the absorbance spectra are determined as set forth in (a)-(c);
P_{LIGHT} is the wavelength-dependent photon fraction (dimensionless) of the light source, determined in steps (d)-(e);
A_{SC}(λ) is the Scatter-Corrected (SC) culture absorbance spectrum, determined in step (c),
thereby determining the algae-specific light source (LS)-dependent absorption cross section σ^{LS} (in m²·g_{DCW}⁻¹), wherein σ^{LS} is assumed to be constant throughout growth of the algal culture; and
(g) measuring the incident Photosynthesis Photon Flux Density I₀ (PPFD), in μE_{INCIDENT}·m⁻²·s⁻¹, wherein 1 Einstein (E) designates 1 mole of photons in the Photosynthetically Active Radiation (PAR) region in the 400-700 nm range; and (h) determining the flux of photons absorbed I_{ABS} by a culture of biomass concentration C, according to the formula:
I_{ABs}(C)=I_{0[}1−exp(−σ^{LS}·C·L)]
wherein
C is the algae culture biomass concentration (in g_{DCW}·m⁻³) that absorbs light;
I₀ is the incident Photosynthesis Photon Flux Density (in μE_{INCIDENT}·m⁻²·h⁻¹);
L is the depth of the culture (culture volume (m³)/area exposed to incident light (m²)); and
σ^{LS} is the algae-specific light source (LS)-dependent absorption cross section (in m²·g_{DCW}⁻¹) determined in step (f),
thereby determining the flux of photons absorbed I_{ABS} (in μE_{ABSORBED}·m⁻²·h⁻¹).

4. A method for determining the Williams-Ferrari-Holland autotrophic yield Φ^{DCW,WFH} of an algal culture that comprises a plurality of algal cells in a liquid algal growth medium, the method comprising:
(a) measuring time t in hours (h) at a plurality of time points during growth of the algal culture, wherein the time t is adjusted to reflect the time the algal culture is exposed to light;
(b) at time t, determining the algal culture absorbance A(t) of a sample of the algal cells to provide a growth curve;
(c) estimating from the growth curve the corresponding algal biomass concentration C(t), using an experimentally determined correlation between absorbance and biomass concentration, k_{abs}, wherein k_{abs} is assumed to be constant throughout growth of the algal culture;
(d) measuring the incident Photosynthesis Photon Flux Density I₀ (PPFD), in μE_{INCIDENT}·m⁻²·s⁻¹, wherein 1 Einstein (E) designates 1 mole of photons in the Photosynthetically Active Radiation (PAR) region in the 400-700 nm range;
(e) at a given culture biomass concentration C_{E}, spectrophotometrically determining the algae culture absorbance spectrum A_{RAW}(λ) over the PAR region;
(f) performing discoloration of the sample of the algal cells to provide discolored algal cells, and at the given culture biomass concentration C_{E}, spectrophotometrically determining the algae culture absorbance spectrum A_{SCATTER}(λ) over the PAR region of the discolored algal cells;
(g) at the given culture biomass concentration C_{E}, calculating the scatter-corrected absorbance spectrum A_{SC}(λ) over the PAR region, according to the formula:
A_{SC}(λ)=A_{RAW}(λ)−A_{SCATTER}(λ)
wherein λ is a wavelength (in nm) in the PAR region (400-700 nm);
(h) acquiring spectrometrically a light source emission spectrum E_{LIGHT}(λ) (in count numbers as a function of λ, wherein count numbers are proportional to the number of photons emitted by the light source);
(i) normalizing the E_{LIGHT}(λ) spectrum over the PAR region, to evaluate the fraction of emitted photons at wavelength λ P_{LIGHT}(λ) according to the formula:
$${P}_{LIGHT} ( λ ) = \frac{{E}_{LIGHT} ( λ )}{{\sum }_{λ = 400}^{700} {E}_{LIGHT} ( λ )} ;$$
(j) at the given culture biomass concentration C_{E}, determining the light spectrum-dependent (LS) algae-specific scatter-corrected absorption cross section, σ^{LS}, wherein σ^{LS} is assumed to be constant throughout growth of the algal culture, according to the formula:
$${σ}^{LS} = \frac{ln 10}{{C}_{E} \cdot {L}_{CUVETTE}} \cdot {\sum }_{λ = 400}^{700} {P}_{LIGHT} ( λ ) \cdot {A}_{SC} ( λ )$$
wherein
λ is a wavelength (in nm) in the PAR region (400-700 nm);
L_{CUVETTE} is the pathlength of the light through the spectrophotometer cuvette (in m);
C_{E} is the algae biomass concentration (in g_{DCW}·m⁻³) at which the absorbance spectra are determined in steps (a)-(c);
P_{LIGHT} is the wavelength-dependent photon fraction (dimensionless) of the light source, as determined in steps (d)-(e);
A_{SC}(λ) is the Scatter-Corrected (SC) culture absorbance spectrum, determined in step (c);
thereby determining the algae-specific light source (LS)-dependent absorption cross section σ^{LS} (in m²·g_{DCW}⁻¹), wherein σ^{LS} is assumed constant throughout growth of the algal culture; and
(k) determining the Williams-Ferrari-Holland autotrophic yield Φ^{DCW,WFH} of the algal culture, from a linear interpolation, according to the formula:
$$\frac{L}{{I}_{0}} \cdot \{ \begin{matrix}C - {C}_{0} + \frac{1}{{σ}^{LS} \cdot L} \cdot \\ ln [ \frac{( 1 - exp ( - {σ}^{LS} \cdot L \cdot C ) )}{( 1 - exp ( - {σ}^{LS} \cdot L \cdot {C}_{0} ) )} ]\end{matrix} \} = {Φ}^{DCW , WFH} \cdot t$$
wherein
t is the time (in h) the algal culture is in the light phase;
C is the algae culture biomass concentration (in g_{DCW}·m⁻³) at time t;
C₀ is the algae culture biomass concentration (in g_{DCW}·m⁻³) at the inoculation time t₀=0;
I₀ is the incident Photosynthesis Photon Flux Density (in μE_{INCIDENT}·m⁻²·h⁻¹);
L is the depth of the culture (culture volume (m³)/area exposed to incident light (m²)); and
σ^{LS} is the algae-specific light source (LS)-dependent absorption cross section (in m²·g_{DCW}⁻¹),
thereby calculating the Williams-Ferrari-Holland autotrophic yield Φ^{DCW,WFH} (in g_{DCW}/μE_{ABSORBED}).

5. The method of claim 3 further comprising determining the rate of biomass fixation in a continuous bioreactor, wherein a light source (LS)-dependent algae-specific biomass production rate is determined according to the formula:
P_{DCW}^{LSi}=Φ^{DCW}·I_{ABS}(C)
wherein
Φ^{DCW} is the algae culture autotrophic biomass yield (in g_{DCW}/μE_{ABSORBED}), determined as (i) Φ^{DCW,ELT} according to the method of claim 1, (ii) Φ^{DCW,WD} according to the method of claim 2, or (iii) Φ^{DCW,WFH} according to the method of claim 4,
thereby determining P_{DCW}^{LSi}, the algae-specific Light Source i (LSi)-dependent algae-specific biomass production rate (in g_{DCW}·m⁻²·d⁻¹).

6. A method for promoting growth of cultured algal cells comprising:
(a) adding carbonate to an algal culture that comprises a plurality of algal cells in a liquid growth medium having a pH that is conducive to growth of the algal cells, and thereby obtaining a concentration of inorganic carbon (Ci) dissolved in the algal culture;
(b) subsequent to (a), adjusting the pH to neutralize the medium to obtain a pH conducive to growth of the algal cells; and
(c) subsequent to (b), sealing the algal culture.

7. The method of claim 6 further comprising determining the autotrophic yield Φ^{DCW,ELT} according to the method of claim 1.
